(19) United States
(12) Patent Application Publication
(10) Pub. No.: US 2026/0276980 A1
(43) Pub. Date: Sep. 17, 2026

(54) IMAGING LENS ASSEMBLY MODULE AND ELECTRONIC DEVICE

(71) Applicant: LARGAN PRECISION CO., LTD., Taichung City (TW)

(72) Inventors: I Yung KUO, Taichung City (TW); Zi Yang CHENG, Taichung City (TW); Wen Cheng HUANG, Taichung City (TW); Heng-Yi SU, Taichung City (TW); Hsiu-Yi HSIAO, Taichung City (TW)

(21) Appl. No.: 19/467,905

(22) Filed: Feb. 3, 2026

(30) Foreign Application Priority Data
Mar. 12, 2025 (TW) 114109242

(51) Int. Cl. G02B 27/00; G02B 7/02; G03B 9/06; G03B 17/12; G03B 17/17; G03B 30/00

(52) U.S. Cl. CPC G02B 27/0018; G02B 7/021; G03B 9/06; G03B 17/12; G03B 17/17; G03B 30/00

(57) ABSTRACT

An imaging lens assembly module includes an optical lens assembly and a single layer light blocking sheet. The single layer light blocking sheet is formed by a uniform medium, the single layer light blocking sheet has a plurality of particles dispersed in the uniform medium, and the single layer light blocking sheet includes an object-side surface, an image-side surface and a light blocking surface. The image-side surface is disposed relative to the object-side surface, and is adjacent to an image side of the imaging lens assembly module. The light blocking surface connects the object-side surface and the image-side surface, and the light blocking surface is closer to the optical axis than each of the object-side surface and the image-side surface to the optical axis. An appearance of the light blocking surface is undulating.

### RELATED APPLICATIONS

This application claims priority to Taiwan Application Serial Number 114109242, filed Mar. 12, 2025, which is herein incorporated by reference.

### BACKGROUND

### Technical Field

The present disclosure relates to an imaging lens assembly module. More particularly, the present disclosure relates to an imaging lens assembly module applicable to portable electronic devices.

### Description of Related Art

In recent years, portable electronic devices have developed rapidly. For example, intelligent electronic devices and tablets have been filled in the lives of modern people, and imaging lens assembly modules mounted on portable electronic devices have also prospered. However, as technology advances, the quality requirements of the imaging lens assembly module are becoming higher and higher. Therefore, an imaging lens assembly module, which can enhance the imaging quality, needs to be developed.

### SUMMARY

The present disclosure provides an imaging lens assembly module, which includes an optical lens assembly and a single layer light blocking sheet. The optical lens assembly defines an optical axis. The single layer light blocking sheet is formed by a uniform medium, and has a plurality of particles dispersed in the uniform medium, the single layer light blocking sheet includes an object-side surface, an image-side surface and a light blocking surface. The image-side surface is disposed relative to the object-side surface, and is adjacent to an image side of the imaging lens assembly module. The light blocking surface connects the object-side surface and the image-side surface, and the light blocking surface is closer to the optical axis than each of the object-side surface and the image-side surface to the optical axis. An appearance of the light blocking surface is undulating, a developed interfacial area ratio of the light blocking surface is Sdr, an arithmetic mean peak curvature of the light blocking surface is Spc, and the following conditions are satisfied: 1.5<Sdr<25; and 15000 mm⁻¹<Spc<150000 mm⁻¹.

According to one aspect of the present disclosure, an electronic device includes the imaging lens assembly module of the aforementioned aspect.

The present disclosure provides an imaging lens assembly module, which includes an optical lens assembly and a variable aperture module. The optical lens assembly defines an optical axis. The variable aperture module includes a plurality of single layer light blocking sheets. The single layer light blocking sheets are disposed around a circumferential direction of the optical axis to form a light through hole, a dimension of the light through hole is changeable, each of the single layer light blocking sheets is formed by a uniform medium, and has a plurality of particles dispersed in the uniform medium, and each of the single layer light blocking sheets includes an object-side surface, an image-side surface and a light blocking surface. The image-side surface is disposed relative to the object-side surface, and is adjacent to an image side of the imaging lens assembly module. The light blocking surface connects the object-side surface and the image-side surface, the light blocking surface extends around the circumferential direction, and the light blocking surface is connected to another one of the light blocking surface by observing along a direction of the optical axis. An appearance of the light blocking surface is undulating.

According to one aspect of the present disclosure, an electronic device includes the imaging lens assembly module of the aforementioned aspect.

### BRIEF DESCRIPTION OF THE DRAWINGS

FIG. 1A is a schematic view of an imaging lens assembly module according to the 1st embodiment of the present disclosure.

FIG. 1B is a schematic view of the single layer light blocking sheet according to the 1st example of the 1st embodiment in FIG. 1A.

FIG. 1C is a three-dimensional view of the single layer light blocking sheet in FIG. 1B.

FIG. 1D is a cross-sectional view along an A1-A1 line in FIG. 1B.

FIG. 1E is an image of the scanning electron microscope (SEM) of an area B1 in FIG. 1C.

FIG. 1F is a schematic view in FIG. 1E.

FIG. 1G is an image of the SEM of an area C1 in FIG. 1D.

FIG. 1H is a schematic view in FIG. 1G.

FIG. 1I is an image of the SEM of the light blocking surface of the single layer light blocking sheet according to the 1st example of the 1st embodiment.

FIG. 1J is a surface roughness profile diagram measuring along a measuring line L1 in FIG. 1I.

FIG. 1K is a schematic view of a single layer light blocking sheet according to the 2nd example of the 1st embodiment in FIG. 1A.

FIG. 2A is a three-dimensional view of an imaging lens assembly module according to the 1st example of the 2nd embodiment of the present disclosure.

FIG. 2B is a schematic view of the imaging lens assembly module in FIG. 2A.

FIG. 2C is a schematic view of the single layer light blocking sheet according to the 1st example of the 2nd embodiment in FIG. 2B.

FIG. 2D is a three-dimensional view of the single layer light blocking sheet in FIG. 2C.

FIG. 2E is a cross-sectional view along an A1-A1 line in FIG. 2C.

FIG. 2F is an image of the SEM of an area B1 in FIG. 2D.

FIG. 2G is a schematic view in FIG. 2F.

FIG. 2H is an image of the SEM of an area C1 in FIG. 2E.

FIG. 2I is a schematic view in FIG. 2H.

FIG. 2J is an image of the SEM of the light blocking surface of the single layer light blocking sheet according to the 1st example of the 2nd embodiment.

FIG. 2K is a surface roughness profile diagram measuring along a measuring line L1 in FIG. 2J.

FIG. 2L is a schematic view of a single layer light blocking sheet according to the 2nd example of the 2nd embodiment in FIG. 2B.

FIG. 2M is a three-dimensional view of the light-folding element in FIG. 2B and the single layer light blocking sheet according to the 2nd example of the 2nd embodiment.

FIG. 2N is a cross-sectional view along an A1-A1 line in FIG. 2L.

FIG. 2O is an image of the SEM of an area B1 in FIG. 2M.

FIG. 2P is a schematic view in FIG. 2O.

FIG. 2Q is an image of the SEM of an area C1 in FIG. 2N.

FIG. 2R is a schematic view in FIG. 2Q.

FIG. 2S is an image of the SEM of the light blocking surface of the single layer light blocking sheet according to the 2nd example of the 2nd embodiment.

FIG. 2T is a surface roughness profile diagram measuring along a measuring line L1 in FIG. 2S.

FIG. 3A is a three-dimensional view of an imaging lens assembly module according to the 1st example of the 3rd embodiment of the present disclosure.

FIG. 3B is a schematic view of the imaging lens assembly module in FIG. 3A.

FIG. 3C is a schematic view of a single layer light blocking sheet according to the 1st example of the 3rd embodiment in FIG. 3B.

FIG. 3D is a three-dimensional view of the single layer light blocking sheet in FIG. 3C.

FIG. 3E is a cross-sectional view along an A1-A1 line in FIG. 3C.

FIG. 3F is an image of the SEM of an area B1 in FIG. 3D.

FIG. 3G is a schematic view in FIG. 3F.

FIG. 3H is an image of the SEM of an area C1 in FIG. 3E.

FIG. 3I is a schematic view in FIG. 3H.

FIG. 3J is an image of the SEM of the light blocking surface of the single layer light blocking sheet according to the 1st example of the 3rd embodiment.

FIG. 3K is a surface roughness profile diagram measuring along a measuring line L1 in FIG. 3J.

FIG. 4A is a three-dimensional view of an imaging lens assembly module according to the 1st example of the 4th embodiment of the present disclosure.

FIG. 4B is a schematic view of the imaging lens assembly module in FIG. 4A.

FIG. 4C is a schematic view of the plurality of single layer light blocking sheets according to the 1st example of the 4th embodiment in FIG. 4B.

FIG. 4D is a three-dimensional view of the plurality of single layer light blocking sheets in FIG. 4C.

FIG. 4E is a cross-sectional view along an A1-A1 line in FIG. 4C.

FIG. 4F is an image of the SEM of an area B1 in FIG. 4D.

FIG. 4G is a schematic view in FIG. 4F.

FIG. 4H is an image of the SEM of an area C1 in FIG. 4E.

FIG. 4I is a schematic view in FIG. 4H.

FIG. 4J is an image of the SEM of the light blocking surface of one of the single layer light blocking sheets according to the 1st example of the 4th embodiment.

FIG. 4K is a surface roughness profile diagram measuring along a measuring line L1 in FIG. 4J.

FIG. 5A is a schematic view of an electronic device according to the 5th embodiment of the present disclosure.

FIG. 5B is another schematic view of the electronic device according to the 5th embodiment in FIG. 5A.

FIG. 5C is a schematic view of an image captured via the electronic device according to the 5th embodiment in FIG. 5A.

FIG. 5D is another schematic view of an image captured via the electronic device according to the 5th embodiment in FIG. 5A.

FIG. 5E is another schematic view of an image captured via the electronic device according to the 5th embodiment in FIG. 5A.

FIG. 6 is a schematic view of an electronic device according to the 6th embodiment of the present disclosure.

FIG. 7A is a schematic view of a vehicle instrument according to the 7th embodiment of the present disclosure.

FIG. 7B is another schematic view of the vehicle instrument according to the 7th embodiment in FIG. 7A.

FIG. 7C is another schematic view of the vehicle instrument according to the 7th embodiment in FIG. 7A.

### DETAILED DESCRIPTION

The present disclosure provides an imaging lens assembly module, which includes an optical lens assembly and a single layer light blocking sheet. The optical lens assembly defines an optical axis. The single layer light blocking sheet is formed by a uniform medium, and has a plurality of particles dispersed in the uniform medium. The single layer light blocking sheet includes an object-side surface, an image-side surface and a light blocking surface. The image-side surface is disposed relative to the object-side surface, and is adjacent to an image side of the imaging lens assembly module. The light blocking surface connects the object-side surface and the image-side surface, and the light blocking surface is closer to the optical axis than each of the object-side surface and the image-side surface to the optical axis. An appearance of the light blocking surface is undulating. When a developed interfacial area ratio of the light blocking surface is Sdr, and an arithmetic mean peak curvature of the light blocking surface is Spc, the following conditions are satisfied: 1.5<Sdr<25; and 15000 mm⁻¹<Spc<150000 mm⁻¹. In particular, the warping problem of the light blocking sheet after baking or assembling can be solved by the single layer light blocking sheet formed by the uniform medium, but the present disclosure is not limited thereto. When the above conditions are satisfied, the light blocking surface has a proper surface roughness. If the surface roughness is too large or too small, the light leakage of the imaging lens assembly module is easily caused or the non-image light is easily caused.

In particular, the traveling direction along the optical axis can be configured to define the object side and the image side of the imaging lens assembly module. All of the object-side surface, the image-side surface and the light blocking surface of the single layer light blocking sheet are formed by the uniform medium, the particles are dispersed thereinto, which is different from the sandwich-typed light blocking sheet of the prior art, for example, the PET sandwich, the PI sandwich, the PC sandwich and the PMMA sandwich. The object-side surface and the image-side surface of the single layer light blocking sheet can also be treated by coating, ink coating, laser or sandblasting so as to further enhance the shielding of the non-imaging light.

The developed interfacial area ratio of the present disclosure means the increment ratio of the developed area of the defined range relative to the area of the defined range, and the area of the defined range can be 1000 μm², but the present disclosure is not limited thereto. The arithmetic mean peak curvature of the present disclosure means the average main curvature of the surface peak.

A part of the particles can be exposed from the light blocking surface. After the appearance of the light blocking surface treated by the stamping pressing, the particle protrusions, the pits formed after removing the particles, the recesses at the periphery of the particles formed after pressing the particles and the remaining fragments formed by the particles spilt in half are exposed at the light blocking surface, so that the appearance of the light blocking surface is undulating. Therefore, the reflection of the non-imaging light at the aforementioned areas can be prevented so as to avoid the flare. It should be mentioned that the particles are dispersed in the uniform medium of the single layer light blocking sheet rather than the partial area.

When the developed interfacial area ratio of the light blocking surface is Sdr, the following condition is satisfied: 3<Sdr<15. Therefore, the mass production can be enhanced under the premise that ensures the optical quality. Further, the following condition can be satisfied: 5<Sdr<13. Further, the following condition can be satisfied: 5.104≤Sdr≤11.45.

When the arithmetic mean peak curvature of the light blocking surface is Spc, the following condition is satisfied: 20000 mm⁻¹<Spc<100000 mm⁻¹. Therefore, the mass production can be enhanced under the premise that ensures the optical quality. Further, the following condition can be satisfied: 22000 mm⁻¹<Spc<95000 mm⁻¹. Further, the following condition can be satisfied: 25000 mm⁻¹<Spc<90000 mm⁻¹. Further, the following condition can be satisfied: 28314.597 mm⁻¹≤Spc≤72862.323 mm⁻¹.

When a diameter of each of the particles is D, the following condition is satisfied: 0.5 μm<D<22 μm. In particular, the diameter is the maximum distance between the boundaries of the particles without limiting the direction. When the above condition is satisfied, the surface roughness of the light blocking surface can be controlled in the proper range. If the diameter of each of the particles is too large or too small, the light blocking surface may be too smooth or rough so as to form the non-imaging light. Further, the following condition can be satisfied: 1.0 μm<D<16 μm. Further, the following condition can be satisfied: 1.807 μm≤D≤11.110 μm.

The aforementioned particles can include silicon dioxide material or acrylate material. Therefore, the original material property of the uniform medium can be changed by adding the particles so as to reinforce the hardness of the single layer light blocking sheet and enhance the stability of the material.

When an arithmetical mean height of a surface of the light blocking surface is Sa, the following condition is satisfied: 0.3 μm<Sa<2.3 μm. Therefore, the proper roughness can be obtained, so that the stray light cannot be easily caused in the imaging lens assembly module. Further, the following condition can be satisfied: 0.45 μm<Sa<1.8 μm. Further, the following condition can be satisfied: 0.636 μm≤Sa≤1.144 μm.

When a gloss difference between the object-side surface and the image-side surface is GL, the following condition is satisfied: 1GU<GL<30GU. Therefore, the manufacturing process of the single layer light blocking sheet can obtain the higher yield rate so as to further enhance the yield rate of the assembling of the imaging lens assembly module. In detail, the gloss is the physical quantity that evaluates the ability of the reflecting light at the material surface under the set of the geometrically defined condition, the gloss is the direction-selective reflecting characteristic, and the gloss meter with the 60-degree angle measurement for measurement is selected by the present disclosure. According to ISO-2813 paints and varnishes-determination of gloss value at 20°, 60° and 85°, wherein 20 degrees is suitable for the measurement of the high-gloss surface, 60 degrees is suitable for the measurement of the semi-gloss surface, and 85 degrees is suitable for the measurement of the matt surface. Further, the following condition can be satisfied: 2GU≤GL<20GU. Further, the following condition can be satisfied: 3GU≤GL<18GU. It should be mentioned that the surface with the lower gloss is relatively rough, and the surface static is easily caused on the surface with the higher gloss, which is relative smooth. However, the warpage or stuck with other elements during assembling of the single layer light blocking sheet by the extremely low or the extremely high gloss. Hence, the aforementioned condition is more suitable for the surface of the single layer light blocking sheet of the present disclosure.

The light blocking surface continuously extends around the optical axis to form a light through hole of the single layer light blocking sheet, and the light through hole is roughly circular. The light through hole can be a polygon formed by connecting a plurality of edges, which can be straight line segments or arc lines, but the present disclosure is not limited thereto. Further, the light through hole is roughly circular, which can be composed of the specific edges, so that the stray light can be effectively blocked.

The imaging lens assembly module can further include a light-folding element located on the optical axis, and the light-folding element is configured to fold the optical axis at least once. The single layer light blocking sheet is disposed on the light-folding element relative to a travelling direction of the optical axis. Therefore, the stray light in the light-folding element can be blocked.

Further, the light blocking surface can extend towards a direction of the optical axis after folding.

When a surface resistivity of the single layer light blocking sheet is R, the following condition is satisfied: 10³ Ω/sq<R<10⁸ Ω/sq. The single layer light blocking sheet is made of uninsulated material, which can be conductive material or static dissipation material. Further, the following condition can be satisfied: 10⁵ Ω/sq<R<10⁷ Ω/sq. Further, when 10³ Ω/sq<R<10⁵ Ω/sq is satisfied, the single layer light blocking sheet is made of conductive material. When 10⁶ Ω/sq<R<10⁸ Ω/sq is satisfied, the single layer light blocking sheet is made of static dissipation material.

When a thickness of the single layer light blocking sheet is TH, the following condition is satisfied: 10 μm<TH<45 μm. If the single layer light blocking sheet is too thin, the worse light-blocking effect is provided. If the single layer light blocking sheet is too thick, the imaging lens assembly module is too large and too heavy. Hence, by disposing the single layer light blocking sheet with the proper thickness, the warpage owing to the assembling or the manufacturing process can be avoided, and the aforementioned problem can also be prevented. Further, the following condition can be satisfied: 20 μm<TH<30 μm.

The present disclosure provides an electronic device, which includes the aforementioned imaging lens assembly module.

The present disclosure provides an imaging lens assembly module, which includes an optical lens assembly and a variable aperture module. The optical lens assembly defines an optical axis. The variable aperture module includes a plurality of single layer light blocking sheets disposed around a circumferential direction of the optical axis to form a light through hole, and a dimension of the light through hole is changeable. Each of the single layer light blocking sheets is formed by a uniform medium, and has a plurality of particles is dispersed in the uniform medium. Each of the single layer light blocking sheets includes an object-side surface, an image-side surface and a light blocking surface. The image-side surface is disposed relative to the object-side surface, and is adjacent to an image side of the imaging lens assembly module. The light blocking surface connects the object-side surface and the image-side surface, the light blocking surface extends around the circumferential direction of the optical axis, and the light blocking surface is connected to another one of the light blocking surface by observing along a direction of the optical axis. An appearance of the light blocking surface is undulating. In detail, the warping problem of the light blocking sheet after baking or assembling can be solved by the single layer light blocking sheet formed by the uniform medium, but the present disclosure is not limited thereto.

In particular, the variable aperture module can be disposed on the most object side of the optical lens assembly or between optical lens elements of the optical lens assembly, but the present disclosure is not limited thereto.

All of the object-side surface, the image-side surface and the light blocking surface of each of the single layer light blocking sheets are formed by the uniform medium, the particles are dispersed thereinto, which is different from the sandwich-typed light blocking sheet of the prior art, for example, the PET sandwich, the PI sandwich, the PC sandwich and the PMMA sandwich. The object-side surface and the image-side surface of each of the single layer light blocking sheets can also be treated by coating, ink coating, laser or sandblasting so as to further enhance the shielding of the non-imaging light.

A part of the particles can be exposed from the light blocking surface. After the appearance of the light blocking surface treated by the stamping pressing, the particle protrusions, the pits formed after removing the particles, the recesses at the periphery of the particles formed after pressing the particles and the remaining fragments formed by the particles spilt in half are exposed at the light blocking surface, so that the appearance of the light blocking surface is undulating. Therefore, the reflection of the non-imaging light at the aforementioned areas can be prevented so as to avoid the flare. It should be mentioned that the particles are dispersed in the uniform medium of each of the single layer light blocking sheets rather than the partial area. The light blocking surface surrounds the optical axis to form the light through hole.

Each of the single layer light blocking sheets can further include a positioning hole and a rotating hole. The positioning hole can be configured to position the single layer light blocking sheets on the variable aperture module, and the rotating hole is configured to provide a moving path so as to make the single layer light blocking sheets to be movable, so that the dimension of the light through hole can be changeable.

Moreover, a shape of the positioning hole is different from a shape of the rotating hole, the positioning hole can be a circular hole, and the rotating hole can be a strip-shaped hole extending towards a direction of the light through hole.

When a developed interfacial area ratio of the light blocking surface is Sdr, the following condition is satisfied: 1<Sdr<25. Therefore, the light blocking surface can have the proper surface roughness. If the roughness is too large or too small, the light leakage of the imaging lens assembly module is easily caused or the non-image light is easily caused. Further, the following condition can be satisfied: 3<Sdr<15. Further, the following condition can be satisfied: 5<Sdr<13.

When an arithmetic mean peak curvature of the light blocking surface is Spc, the following condition is satisfied: 15000 mm⁻¹<Spc<150000 mm⁻¹. Therefore, the light blocking surface can have the proper surface roughness. If the roughness is too large or too small, the light leakage of the imaging lens assembly module is easily caused or the non-image light is easily caused. Further, the following condition can be satisfied: 20000 mm⁻¹<Spc<100000 mm⁻¹. Further, the following condition can be satisfied: 22000 mm⁻¹<Spc<95000 mm⁻¹. Further, the following condition can be satisfied: 25000 mm⁻¹<Spc<90000 mm⁻¹.

When a diameter of each of the particles is D, the following condition is satisfied: 0.5 μm<D<22 μm. Therefore, the surface roughness of the light blocking surface can be controlled in the proper range. If the diameter of each of the particles is too large or too small, the light blocking surface may be too smooth or rough so as to form the non-imaging light. Further, the following condition can be satisfied: 1.0 μm<D<16 μm.

The aforementioned particles can include silicon dioxide material or acrylate material. Therefore, the original material property of the uniform medium can be changed by adding the particles so as to reinforce the hardness of each of the single layer light blocking sheets and enhance the stability of the material.

When an arithmetical mean height of a surface of the light blocking surface is Sa, the following condition is satisfied: 0.3 μm<Sa<2.3 μm. Therefore, the proper roughness can be obtained, so that the stray light cannot be easily caused in the imaging lens assembly module. Further, the following condition can be satisfied: 0.45 μm<Sa<1.8 μm.

When a surface resistivity of each of the single layer light blocking sheets is R, the following condition is satisfied: 10³ Ω/sq<R<10⁸ Ω/sq. Each of the single layer light blocking sheets is made of uninsulated material, which can be conductive material or static dissipation material. Further, the following condition can be satisfied: 10⁵ Ω/sq<R<10⁷ Ω/sq. Further, when 10³ Ω/sq<R<10⁵ Ω/sq is satisfied, each of the single layer light blocking sheets is made of conductive material. When 10⁶ Ω/sq<R<10⁸ Ω/sq is satisfied, each of the single layer light blocking sheets is made of static dissipation material.

The present disclosure provides an electronic device, which includes the aforementioned imaging lens assembly module.

It should be mentioned that the parameters of the present disclosure are measured via VK-X31000 to measure the imaging lens assembly module. During measuring, the light blocking surface to be measured is tilted to keep in horizon with the imaging lens assembly module, and the software planar correction is performed after 3D scanning. The parameter data of the present disclosure is to tilt the light blocking surface 70 degrees, the measurement magnification of the imaging lens assembly module is 2400×, and the fixed area (100 μm×10 μm) is selected to perform the measurement of the surface roughness. Further, the definition of all of the parameters (which include Sa, Sz, Sdr, Spc, Sdq) of the surface roughness used or mentioned in the present disclosure refers to ISO-25178 geometrical product specification (GPS)-surface texture: areal, which is a kind of the international standard specification parameter for evaluating the surface roughness.

### 1st Embodiment

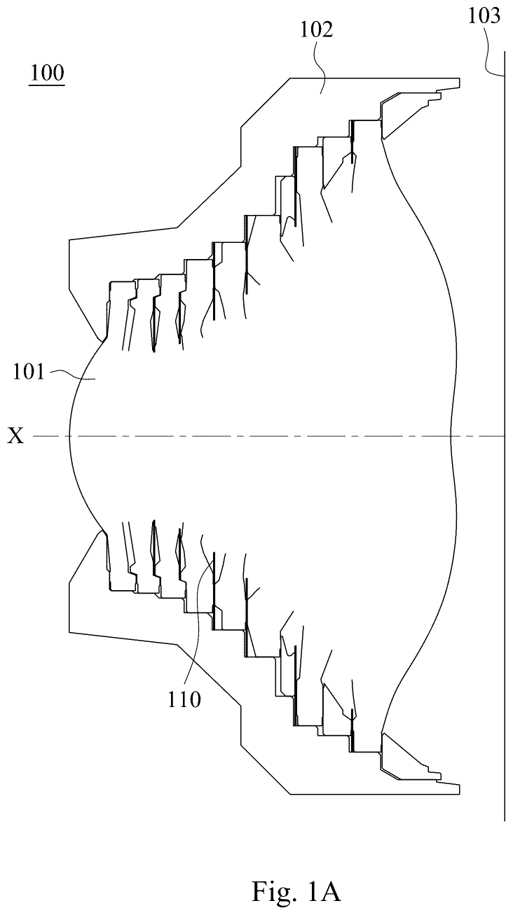

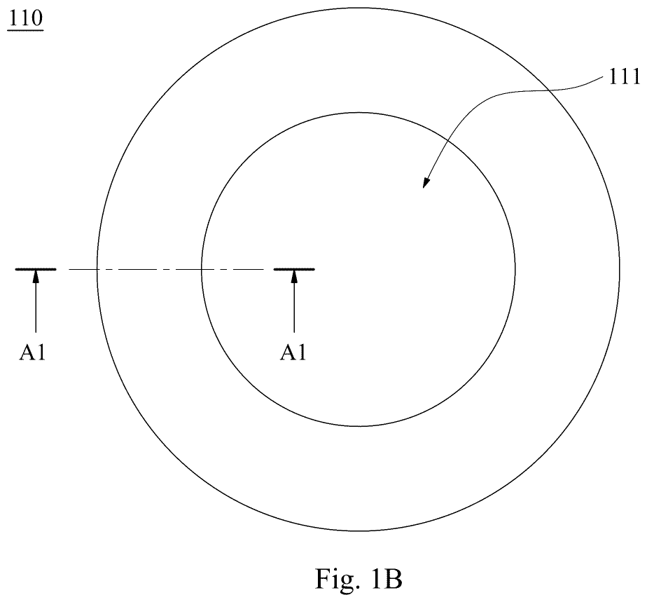

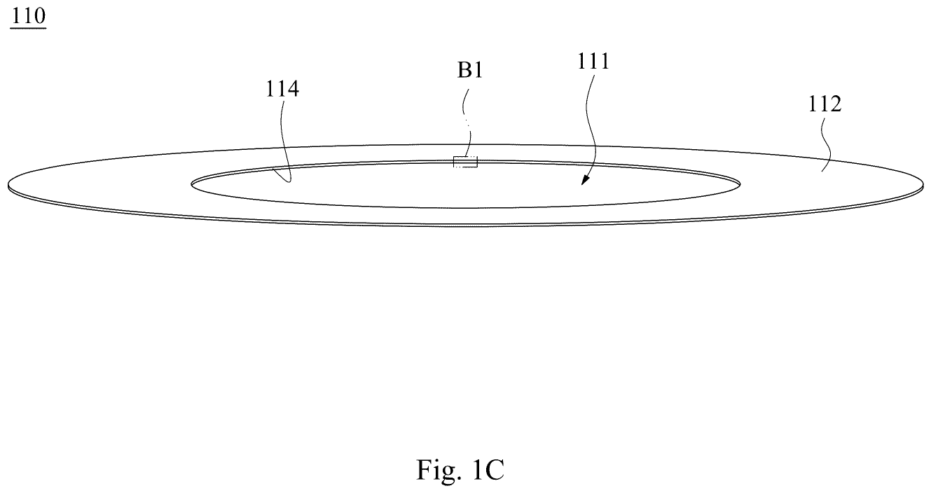

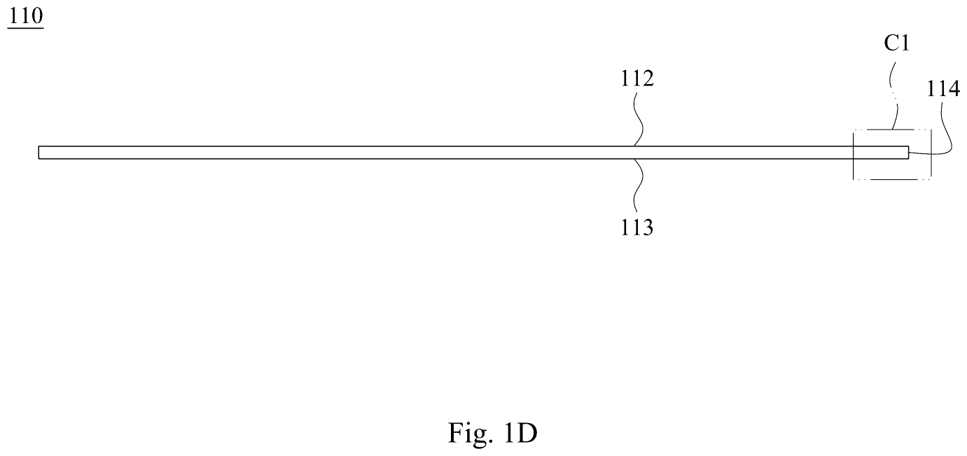

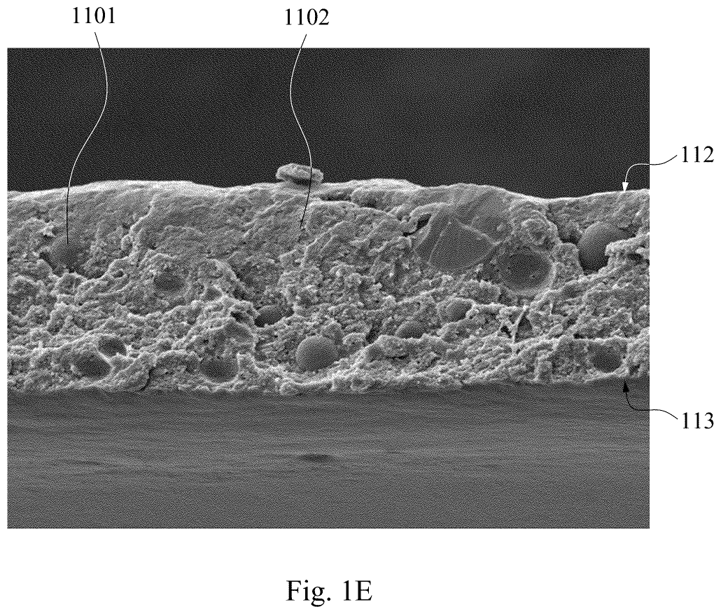

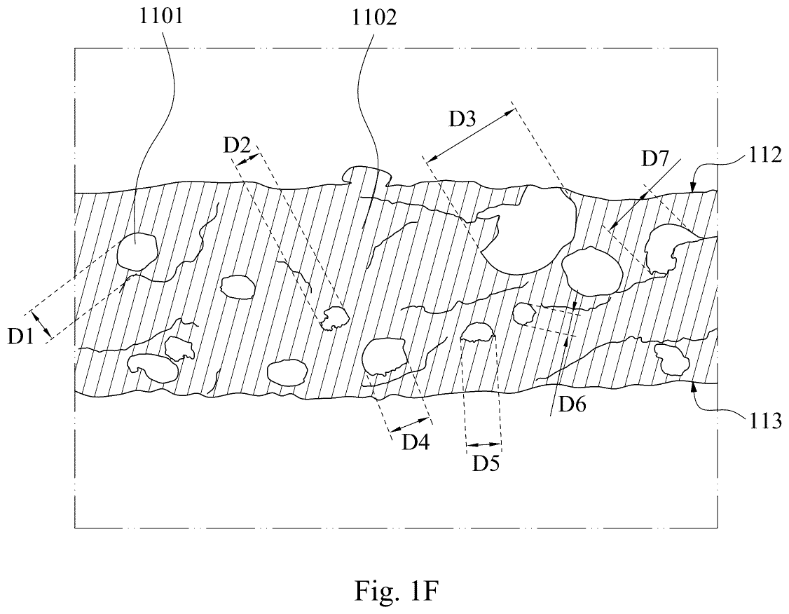

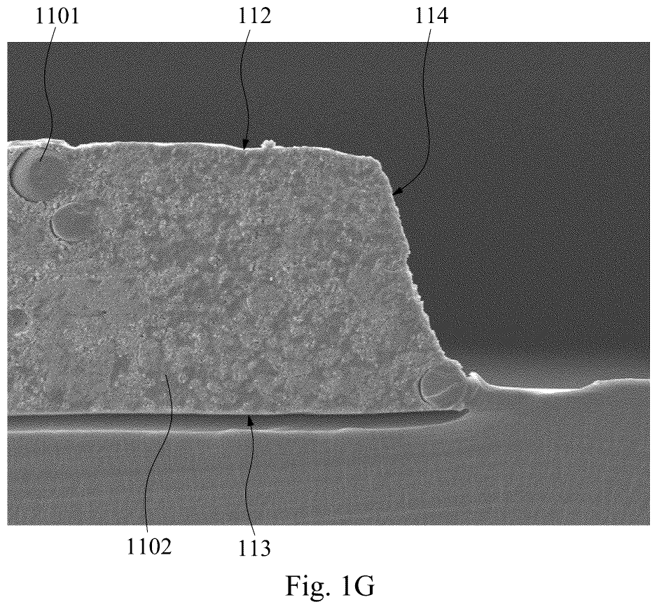

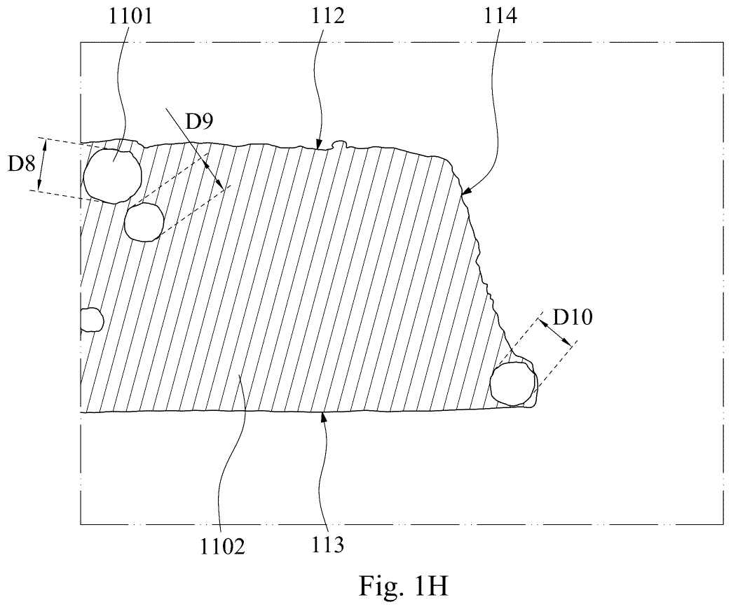

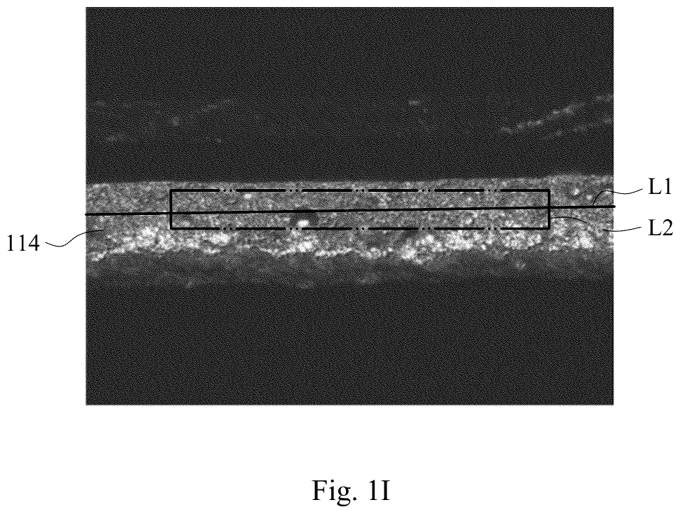

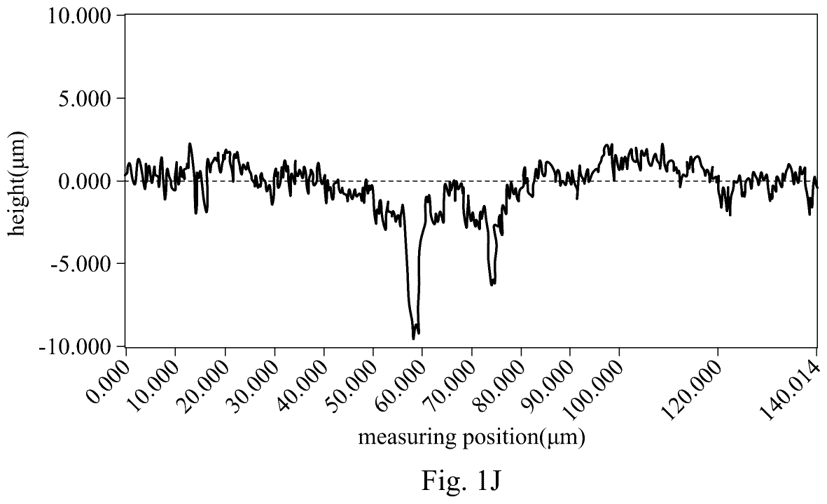

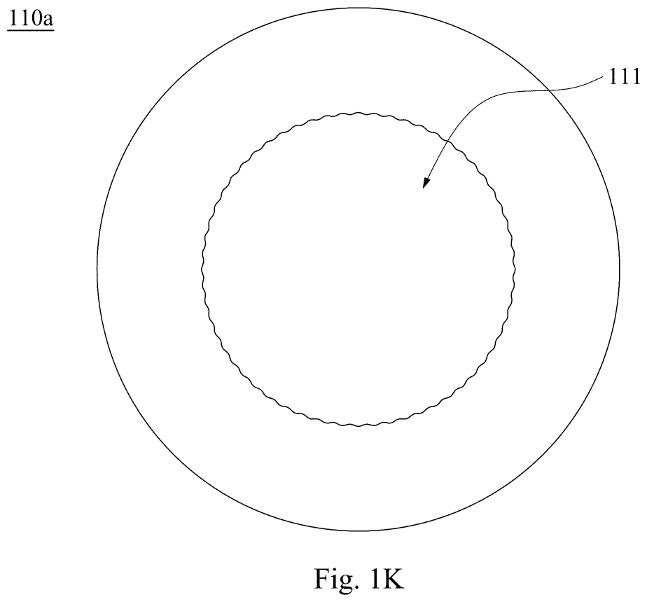

FIG. 1A is a schematic view of an imaging lens assembly module 100 according to the 1st embodiment of the present disclosure. In FIG. 1A, the imaging lens assembly module 100 includes an optical lens assembly 101 and a single layer light blocking sheet 110. The optical lens assembly 101 defines an optical axis X, and can include a plurality of optical lens elements (their reference numerals are omitted) disposed along the optical axis X. The single layer light blocking sheet 110 is disposed between any two of the optical lens elements. Further, the imaging lens assembly module 100 can further include other optical elements according to the requirements, such as a light blocking element, a retainer, but the present disclosure is not limited thereto. Moreover, the imaging lens assembly module 100 can further include a lens barrel element 102, and the optical lens assembly 101 and the single layer light blocking sheet 110 can be disposed therein, and an image is imaged on an image surface 103.

FIG. 1B is a schematic view of the single layer light blocking sheet 110 according to the 1st example of the 1st embodiment in FIG. 1A. FIG. 1C is a three-dimensional view of the single layer light blocking sheet 110 in FIG. 1B. FIG. 1D is a cross-sectional view along an A1-A1 line in FIG. 1B. In FIGS. 1B to 1D, the single layer light blocking sheet 110 includes an object-side surface 112, an image-side surface 113 and a light blocking surface 114. The image-side surface 113 is disposed relative to the object-side surface 112, and is adjacent to an image side of the imaging lens assembly module 100. The light blocking surface 114 connects the object-side surface 112 and the image-side surface 113, and the light blocking surface 114 is closer to the optical axis X than each of the object-side surface 112 and the image-side surface 113 to the optical axis X. The light blocking surface 114 continuously extends around the optical axis X to form a light through hole 111 of the single layer light blocking sheet 110.

FIG. 1E is an image of the SEM of an area B1 in FIG. 1C. FIG. 1F is a schematic view in FIG. 1E. FIG. 1G is an image of the SEM of an area C1 in FIG. 1D. FIG. 1H is a schematic view in FIG. 1G. In FIGS. 1E to 1H, the single layer light blocking sheet 110 is formed by a uniform medium 1102, and has a plurality of particles 1101 dispersed in the uniform medium 1102. An appearance of the light blocking surface 114 is undulating. A part of the particles 1101 is exposed from the light blocking surface 114. The particles 1101 can include silicon dioxide material or acrylate material.

According to the 1st example of the 1st embodiment, a diameter of each of the particles 1101 is D. In particular, the diameters of ten of the particles 1101 in FIGS. 1F and 1H are listed and labelled D1 to D10, respectively, and the values thereof is: D1=2.946 μm, D2=2.473 μm, D3=8.594 μm, D4=3.530 μm, D5=2.603 μm, D6=1.807 μm, D7=4.815 μm, D8=4.602 μm, D9=3.166 μm, and D10=4.014 μm. It should be mentioned that the above only lists the diameters of a portion of the particles 1101, but the present disclosure is not limited thereto.

FIG. 1I is an image of the SEM of the light blocking surface 114 of the single layer light blocking sheet 110 according to the 1st example of the 1st embodiment, wherein the measuring range of the related data of the roughness of the light blocking surface 114 of the single layer light blocking sheet 110 of the present disclosure is the area L2 in FIG. 1I. FIG. 1J is a surface roughness profile diagram measuring along a measuring line L1 in FIG. 1I, wherein the horizontal axis is the measuring position on the measuring path, and the unit is μm; the vertical axis is the undulation height of the light blocking surface 114, and the unit is μm. The undulating appearance of the light blocking surface 114 can be quantified via FIGS. 11 and 1J.

According to the 1st example of the 1st embodiment, a developed interfacial area ratio of the light blocking surface 114 is Sdr; an arithmetic mean peak curvature of the light blocking surface 114 is Spc; an arithmetical mean height of a surface of the light blocking surface 114 is Sa; a gloss difference between the object-side surface 112 and the image-side surface 113 is GL; a surface resistivity of the single layer light blocking sheet 110 is R; a thickness of the single layer light blocking sheet 110 is TH; a maximum height of the light blocking surface 114 is Sz, and the following conditions of Table 1A are satisfied.

TABLE 1A
the 1st example of the 1st embodiment

| | | | |
|---|---|---|---|
| Sdr | 11.45 | R (Ω/sq) | 5.95 × 10⁴ |
| Spc (mm⁻¹) | 55811.130 | TH (μm) | 21.2 |
| Sa (μm) | 1.117 | Sz (μm) | 14.553 |
| GL | 1.5GU | | |

Furthermore, the surface roughness parameters of the object-side surface 112 and the image-side surface 113 of the single layer light blocking sheet 110 according to the 1st example of the 1st embodiment are shown in Tables 1B and 1C. In Table 1B, an arithmetical mean height of a surface of the object-side surface 112 is Sa, a maximum height of the object-side surface 112 is Sz, a developed interfacial area ratio of the object-side surface 112 is Sdr, an arithmetic mean peak curvature of the object-side surface 112 is Spc, and a root mean square gradient of the object-side surface 112 is Sdq, which is calculated according to the root mean square of all of the points in the defined area; Sdq of the entirely flat surface is 0. In Table 1C, an arithmetical mean height of the surface of the image-side surface 113 is Sa, a maximum height of the image-side surface 113 is Sz, a developed interfacial area ratio of the image-side surface 113 is Sdr, an arithmetic mean peak curvature of the image-side surface 113 is Spc, and a root mean square gradient of the image-side surface 113 is Sdq.

TABLE 1B
the 1st example of the 1st embodiment (the object-side surface
112 of the single layer light blocking sheet 110)

| | | | |
|---|---|---|---|
| Sa (μm) | 0.56 | Spc (mm⁻¹) | 18226.53 |
| Sz (μm) | 8.71 | Sdq | 2.23 |
| Sdr | 1.77 | | |

TABLE 1C
the 1st example of the 1st embodiment (the image-side surface
113 of the single layer light blocking sheet 110)

| | | | |
|---|---|---|---|
| Sa (μm) | 0.92 | Spc (mm⁻¹) | 45970.95 |
| Sz (μm) | 10.27 | Sdq | 4.99 |
| Sdr | 8.26 | | |

FIG. 1K is a schematic view of a single layer light blocking sheet 110a according to the 2nd example of the 1st embodiment in FIG. 1A. In FIG. 1K, one of the differences between the single layer light blocking sheet 110a according to the 2nd example of the 1st embodiment and the single layer light blocking sheet 110 according to the 1st example of the 1st embodiment is the light blocking surface (its reference numeral is omitted) of the single layer light blocking sheet 110a continuously extends around the optical axis (its reference numeral is omitted) to form a light through hole 111 of the single layer light blocking sheet 110a, and the light through hole 111 is roughly circular.

Further, the surface roughness parameters of the image-side surface (its reference numeral is omitted) of the single layer light blocking sheet 110a according to the 2nd example of the 1st embodiment are shown in Table 1D, wherein the definition of the parameters are the same as the corresponding definition of the parameters in Table 1C according to the 1st example of the 1st embodiment, and will not be described again herein.

TABLE 1D
the 2nd example of the 1st embodiment (the image-side
surface of the single layer light blocking sheet 110a)

| | | | |
|---|---|---|---|
| Sa (μm) | 0.87 | Spc (mm⁻¹) | 47416.04 |
| Sz (μm) | 11.34 | Sdq | 5.06 |
| Sdr | 8.56 | | |

It should be mentioned that all of another structure characteristics and the parameters of the single layer light blocking sheet 110a and another elements of the imaging lens assembly module 100 according to the 2nd example of the 1st embodiment in FIG. 1K can be the same or similar to the 1st example of the 1st embodiment, and will not be described again herein.

### 2nd Embodiment

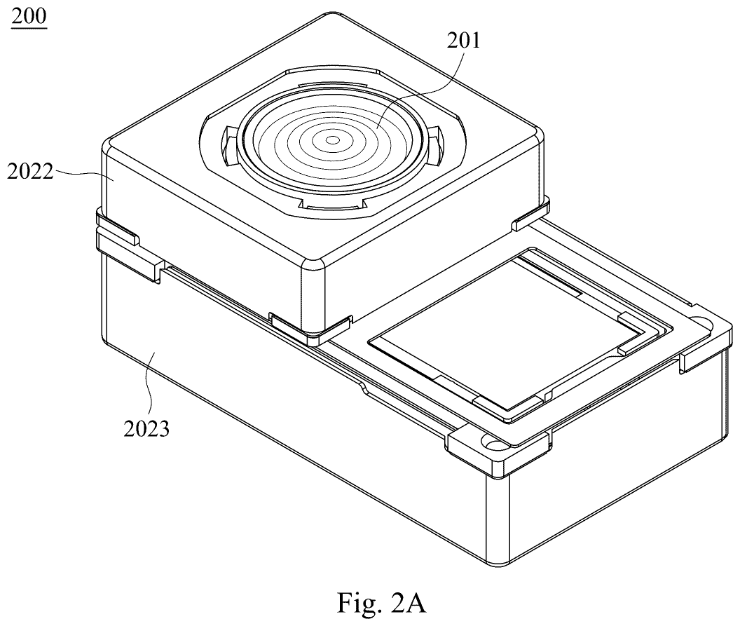

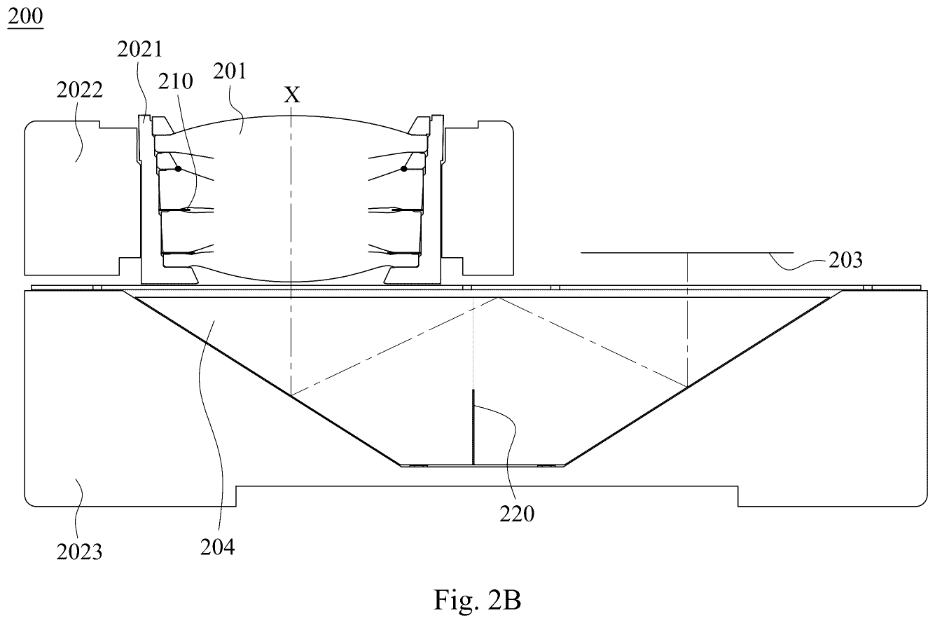

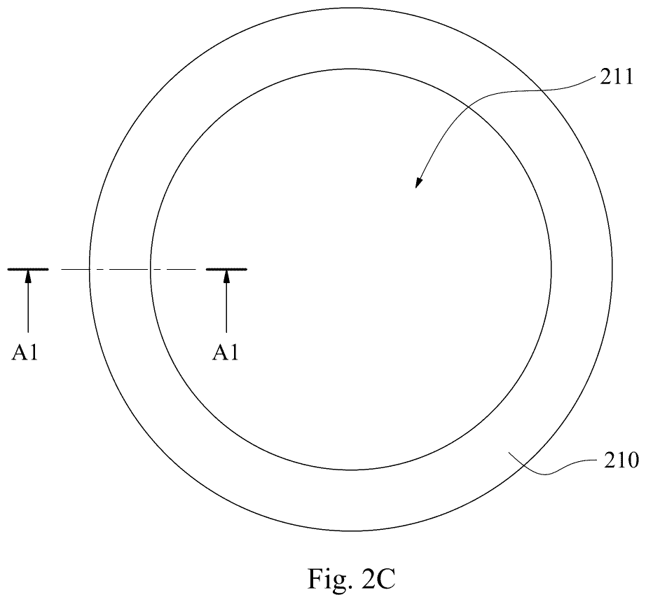

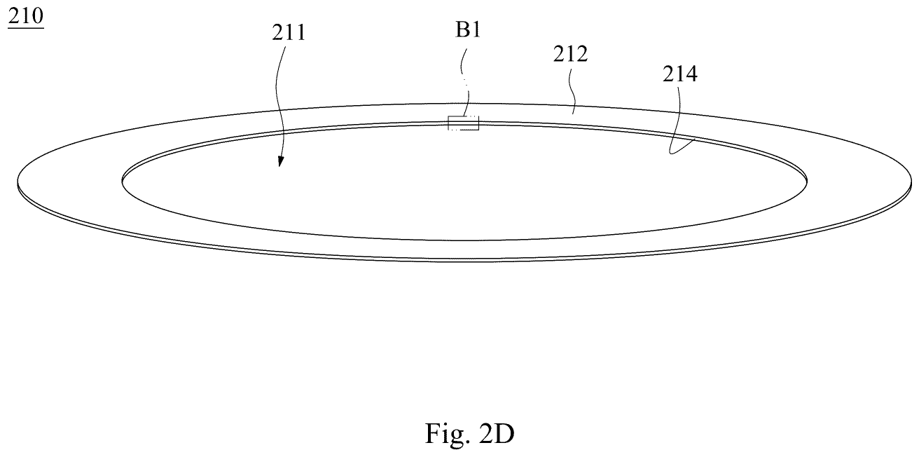

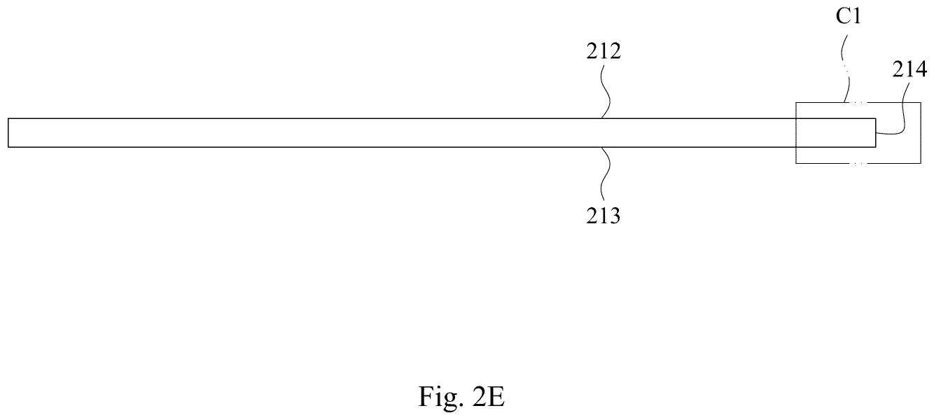

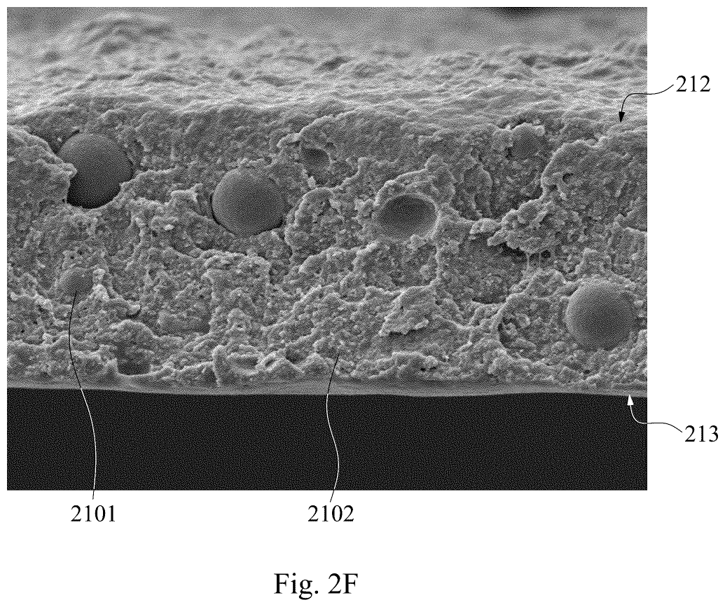

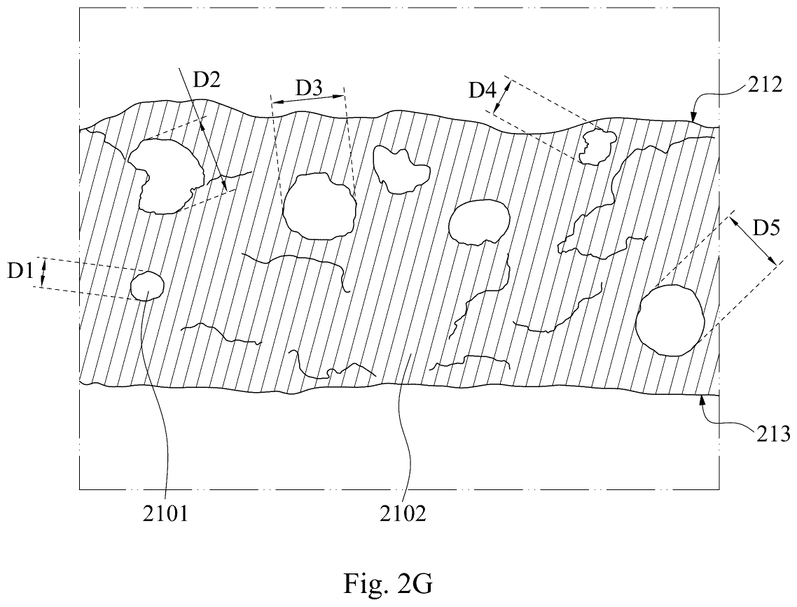

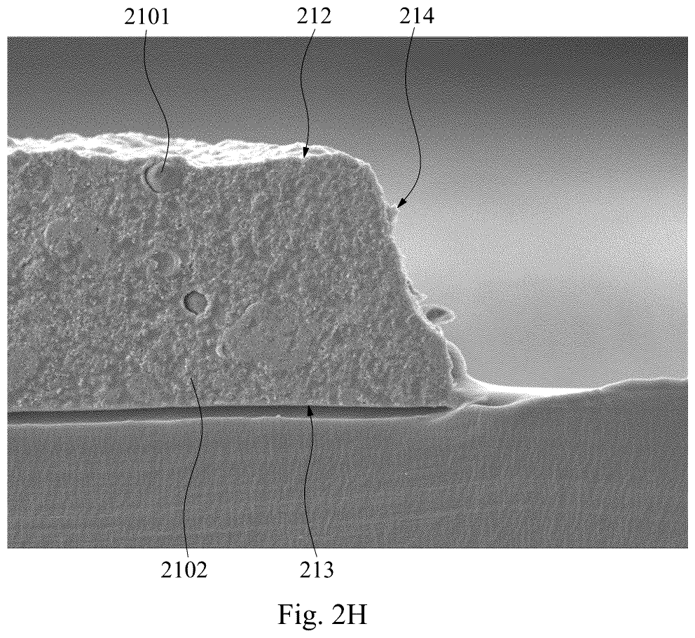

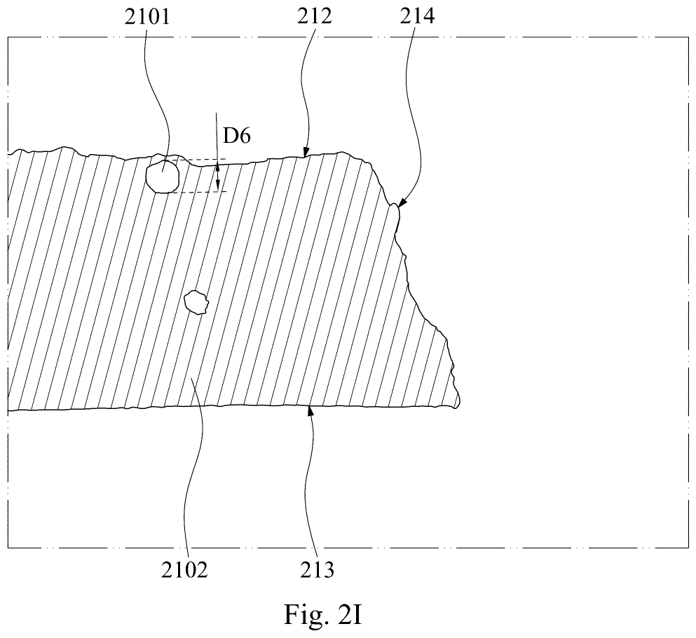

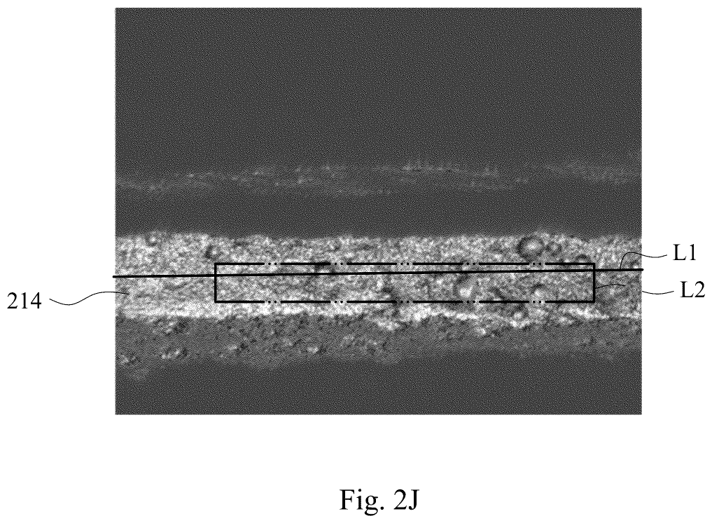

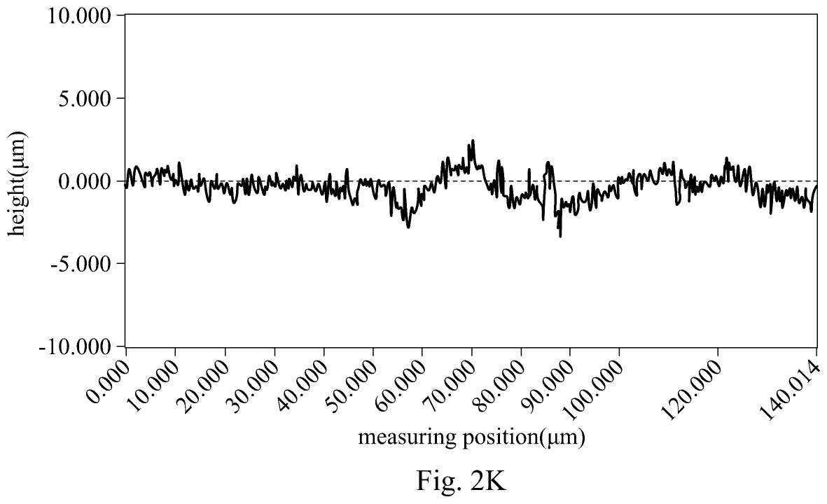

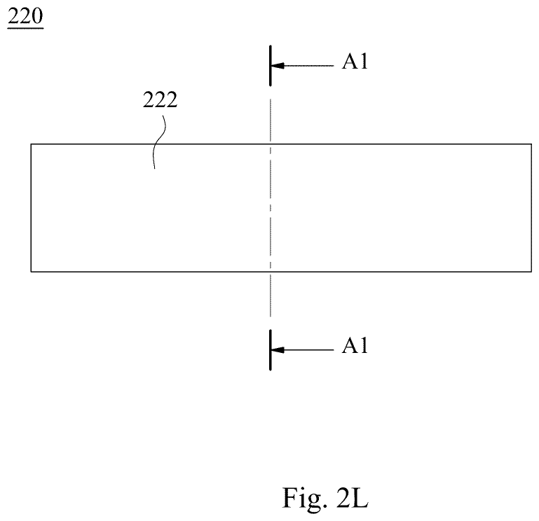

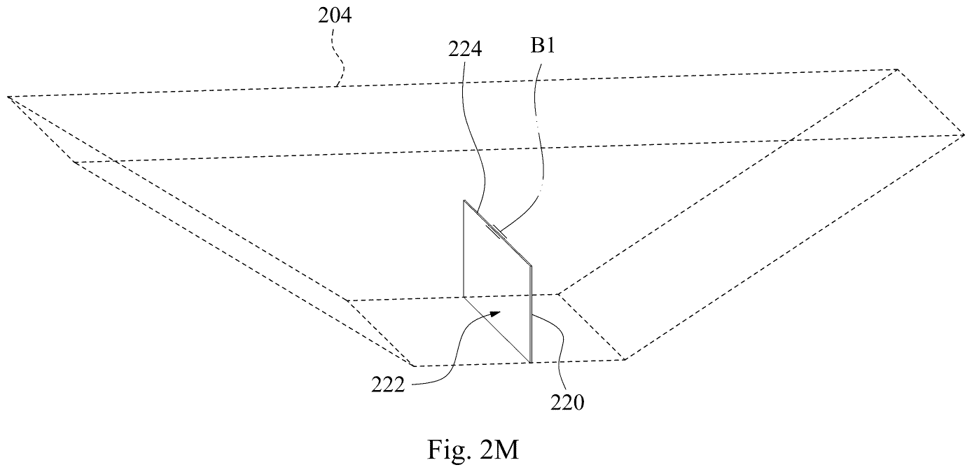

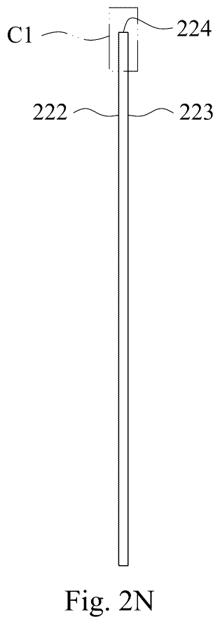

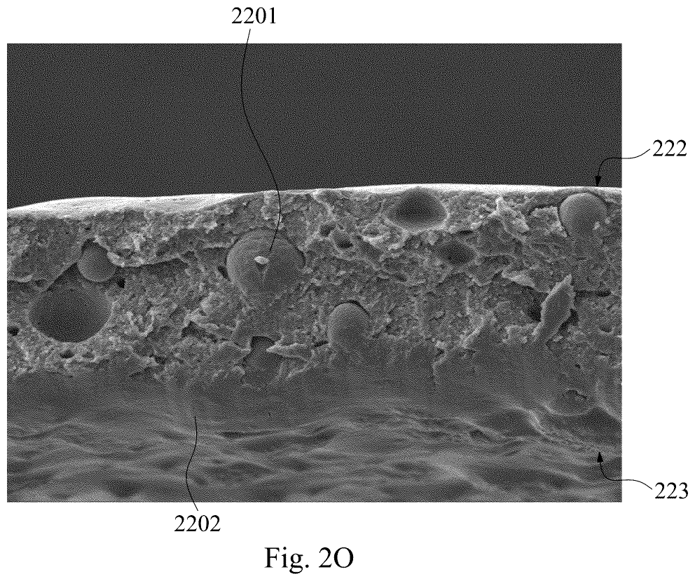

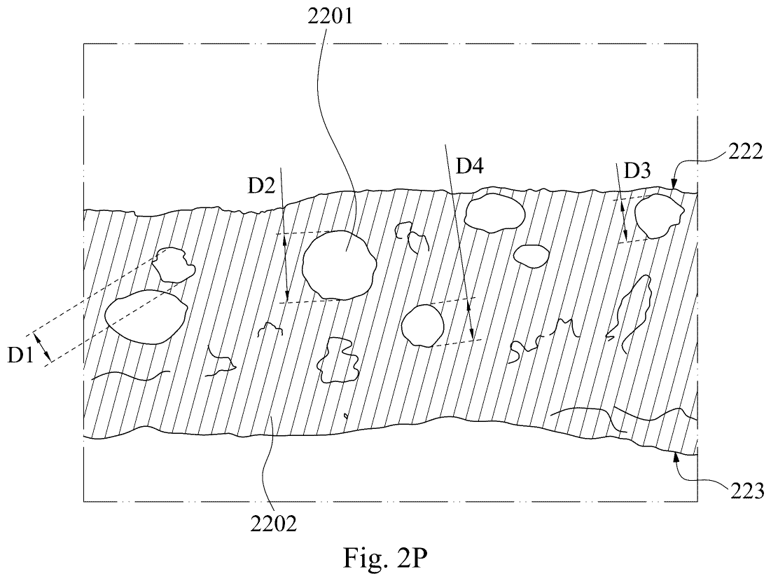

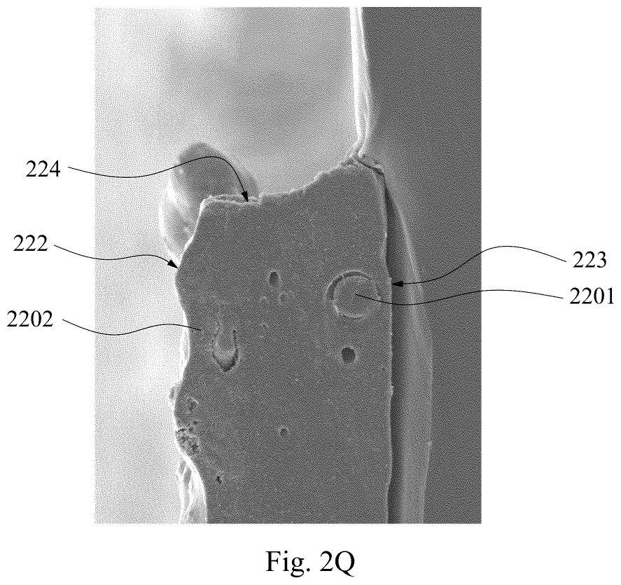

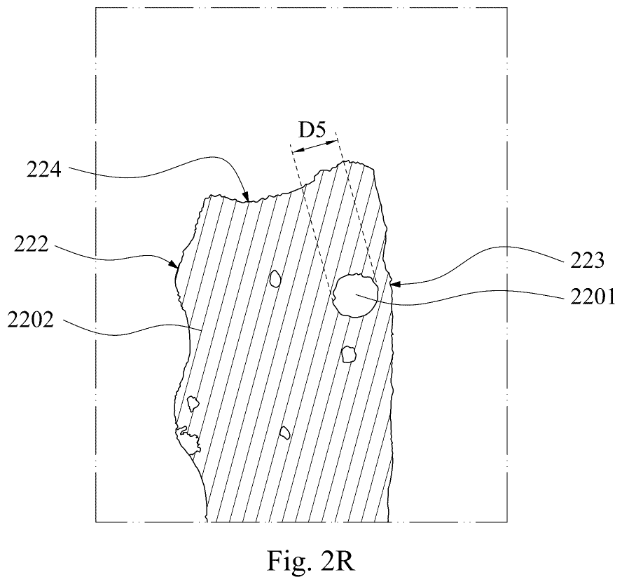

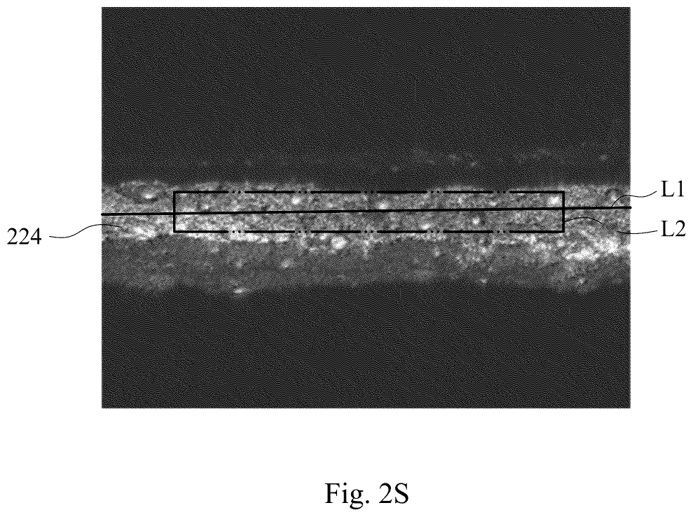

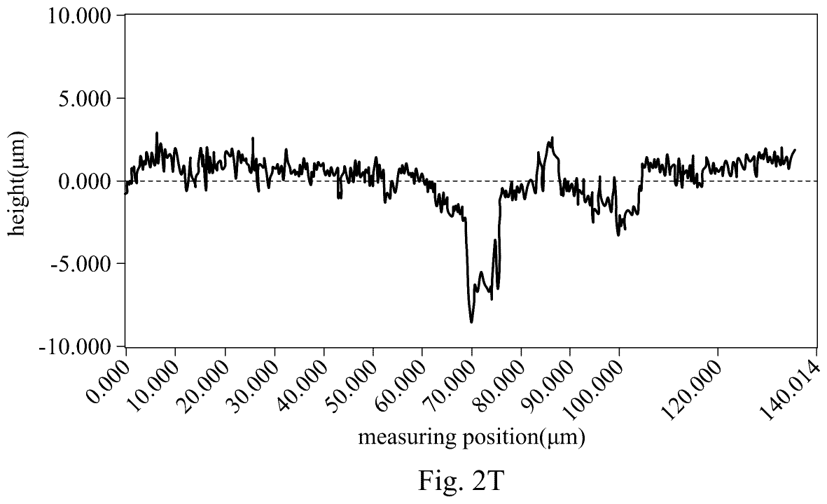

FIG. 2A is a three-dimensional view of an imaging lens assembly module 200 according to the 1st example of the 2nd embodiment of the present disclosure. FIG. 2B is a schematic view of the imaging lens assembly module 200 in FIG. 2A. In FIGS. 2A and 2B, the imaging lens assembly module 200 includes an optical lens assembly 201, a light-folding element 204 and two single layer light blocking sheets 210, 220. The optical lens assembly 201 defines an optical axis X, and can include a plurality of optical lens elements (their reference numerals are omitted) disposed along the optical axis X. The light-folding element 204 is located between the optical lens assembly 201 and an image surface 203 and on the optical axis X, and the light-folding element 204 is configured to fold the optical axis X at least once. The single layer light blocking sheet 210 is disposed between any two of the optical lens elements, and the single layer light blocking sheet 220 is disposed in the light-folding element 204. Further, the imaging lens assembly module 200 can further include other optical elements according to the requirements, such as a light blocking element, a retainer, but the present disclosure is not limited thereto. Moreover, the imaging lens assembly module 200 can further include a lens barrel element 2021, a cover 2022 and a base 2023, wherein the optical lens assembly 201 and the single layer light blocking sheet 210 can be disposed in the lens barrel element 2021 and mounted in the cover 2022, the light-folding element 204 is disposed in the base 2023, and the base 2023 and the cover 2022 are assembled so as to make the light-folding element 204 be located on the image side of the optical lens assembly 201. Therefore, the imaging light enters from the object side of the optical lens assembly 201, and the imaging light is folded via the light-folding element 204 and then imaged on the image surface 203.

FIG. 2C is a schematic view of the single layer light blocking sheet 210 according to the 1st example of the 2nd embodiment in FIG. 2B. FIG. 2D is a three-dimensional view of the single layer light blocking sheet 210 in FIG. 2C. FIG. 2E is a cross-sectional view along an A1-A1 line in FIG. 2C. In FIGS. 2C to 2E, the single layer light blocking sheet 210 includes an object-side surface 212, an image-side surface 213 and a light blocking surface 214. The image-side surface 213 is disposed relative to the object-side surface 212, and is adjacent to an image side of the imaging lens assembly module 200. The light blocking surface 214 connects the object-side surface 212 and the image-side surface 213, and the light blocking surface 214 is closer to the optical axis X than each of the object-side surface 212 and the image-side surface 213 to the optical axis X. The light blocking surface 214 continuously extends around the optical axis X to form a light through hole 211 of the single layer light blocking sheet 210.

FIG. 2F is an image of the SEM of an area B1 in FIG. 2D. FIG. 2G is a schematic view in FIG. 2F. FIG. 2H is an image of the SEM of an area C1 in FIG. 2E. FIG. 2I is a schematic view in FIG. 2H. In FIGS. 2F to 21, the single layer light blocking sheet 210 is formed by a uniform medium 2102, and has a plurality of particles 2101 dispersed in the uniform medium 2102. An appearance of the light blocking surface 214 is undulating. A part of the particles 2101 is exposed from the light blocking surface 214. The particles 2101 can include silicon dioxide material or acrylate material.

According to the 1st example of the 2nd embodiment, a diameter of each of the particles 2101 of the single layer light blocking sheet 210 is D. In particular, the diameters of six of the particles 2101 in FIGS. 2G and 21 are listed and labelled D1 to D6, respectively, and the values thereof is: D1=2.708 μm, D2=6.208 μm, D3=5.621 μm, D4=3.135 μm, D5=6.015 μm, and D6=2.210 μm. It should be mentioned that the above only lists the diameters of a portion of the particles 2101, but the present disclosure is not limited thereto.

FIG. 2J is an image of the SEM of the light blocking surface 214 of the single layer light blocking sheet 210 according to the 1st example of the 2nd embodiment, wherein the measuring range of the related data of the roughness of the light blocking surface 214 of the single layer light blocking sheet 210 of the present disclosure is the area L2 in FIG. 2J. FIG. 2K is a surface roughness profile diagram measuring along a measuring line L1 in FIG. 2J, wherein the horizontal axis is the measuring position on the measuring path, and the unit is μm; the vertical axis is the undulation height of the light blocking surface 214, and the unit is μm. The undulating appearance of the light blocking surface 214 can be quantified via FIGS. 2J and 2K.

According to the 1st example of the 2nd embodiment, a developed interfacial area ratio of the light blocking surface 214 of the single layer light blocking sheet 210 is Sdr; an arithmetic mean peak curvature of the light blocking surface 214 is Spc; an arithmetical mean height of a surface of the light blocking surface 214 is Sa; a gloss difference between the object-side surface 212 and the image-side surface 213 is GL; a surface resistivity of the single layer light blocking sheet 210 is R; a thickness of the single layer light blocking sheet 210 is TH; a maximum height of the light blocking surface 214 is Sz, and the following conditions of Table 2A are satisfied.

TABLE 2A
the 1st example of the 2nd embodiment (the
single layer light blocking sheet 210)

| | | | |
|---|---|---|---|
| Sdr | 11.40 | R (Ω/sq) | 1.8 × 10⁶ |
| Spc (mm⁻¹) | 66534.017 | TH (μm) | 23.1 |
| Sa (μm) | 0.891 | Sz (μm) | 15.792 |
| GL | 16.7GU | | |

FIG. 2L is a schematic view of a single layer light blocking sheet 220 according to the 2nd example of the 2nd embodiment in FIG. 2B. FIG. 2M is a three-dimensional view of the light-folding element 204 in FIG. 2B and the single layer light blocking sheet 220 according to the 2nd example of the 2nd embodiment. FIG. 2N is a cross-sectional view along an A1-A1 line in FIG. 2L. In FIGS. 2B, 2L, 2M and 2N, the single layer light blocking sheet 220 according to the 2nd example of the 2nd embodiment is disposed on the light-folding element 204 relative to a travelling direction of the optical axis X. The single layer light blocking sheet 220 includes an object-side surface 222, an image-side surface 223 and a light blocking surface 224. The image-side surface 223 is disposed relative to the object-side surface 222, and is adjacent to an image side of the imaging lens assembly module 200. The light blocking surface 224 connects the object-side surface 222 and the image-side surface 223, and the light blocking surface 224 is closer to the optical axis X than each of the object-side surface 222 and the image-side surface 223 to the optical axis X. In particular, the light blocking surface 224 extends towards a direction of the optical axis X after folding.

FIG. 2O is an image of the SEM of an area B1 in FIG. 2M. FIG. 2P is a schematic view in FIG. 2O. FIG. 2Q is an image of the SEM of an area C1 in FIG. 2N. FIG. 2R is a schematic view in FIG. 2Q. In FIGS. 20 to 2R, the single layer light blocking sheet 220 is formed by a uniform medium 2202, and has a plurality of particles 2201 dispersed in the uniform medium 2202. An appearance of the light blocking surface 224 is undulating. A part of the particles 2201 is exposed from the light blocking surface 224. The particles 2201 can include silicon dioxide material or acrylate material.

According to the 2nd example of the 2nd embodiment, a diameter of each of the particles 2201 of the single layer light blocking sheet 220 is D. In particular, the diameters of five of the particles 2201 in FIGS. 2P and 2R are listed and labelled D1 to D5, respectively, and the values thereof is: D1=3.910 μm, D2=5.736 μm, D3=3.645 μm, D4=3.643 μm, and D5=4.955 μm. It should be mentioned that the above only lists the diameters of a portion of the particles 2201, but the present disclosure is not limited thereto.

FIG. 2S is an image of the SEM of the light blocking surface 224 of the single layer light blocking sheet 220 according to the 2nd example of the 2nd embodiment, wherein the measuring range of the related data of the roughness of the light blocking surface 224 of the single layer light blocking sheet 220 of the present disclosure is the area L2 in FIG. 2S. FIG. 2T is a surface roughness profile diagram measuring along a measuring line L1 in FIG. 2S, wherein the horizontal axis is the measuring position on the measuring path, and the unit is μm; the vertical axis is the undulation height of the light blocking surface 224, and the unit is μm. The undulating appearance of the light blocking surface 224 can be quantified via FIGS. 2S and 2T.

According to the 2nd example of the 2nd embodiment, a developed interfacial area ratio of the light blocking surface 224 of the single layer light blocking sheet 220 is Sdr; an arithmetic mean peak curvature of the light blocking surface 224 is Spc; an arithmetical mean height of a surface of the light blocking surface 224 is Sa; a gloss difference between the object-side surface 222 and the image-side surface 223 is GL; a surface resistivity of the single layer light blocking sheet 220 is R; a thickness of the single layer light blocking sheet 220 is TH; a maximum height of the light blocking surface 224 is Sz, and the following conditions of Table 2B are satisfied.

TABLE 2B
the 2nd example of the 2nd embodiment (the
single layer light blocking sheet 220)

| | | | |
|---|---|---|---|
| Sdr | 10.23 | R (Ω/sq) | 3.5 × 10¹⁰ |
| Spc (mm⁻¹) | 71170.616 | TH (μm) | 24 |
| Sa (μm) | 1.144 | Sz (μm) | 14.198 |
| GL | 16.2GU | | |

### 3rd Embodiment

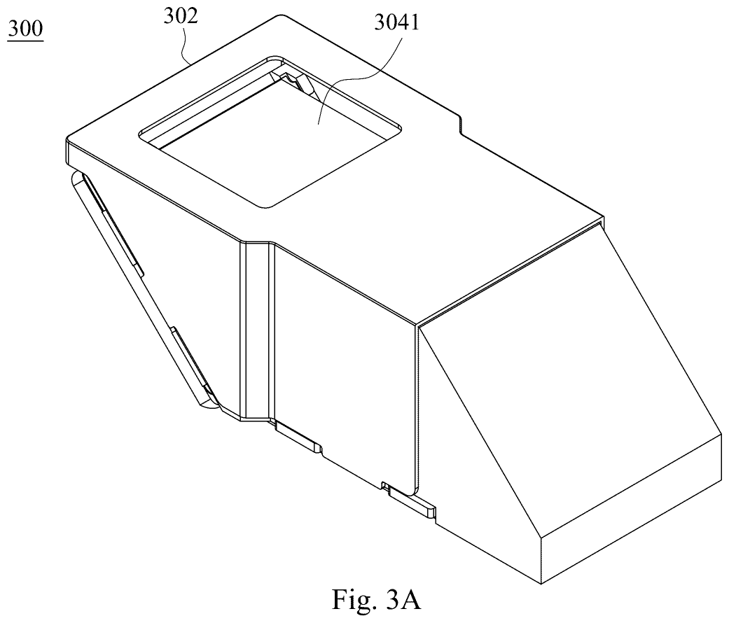

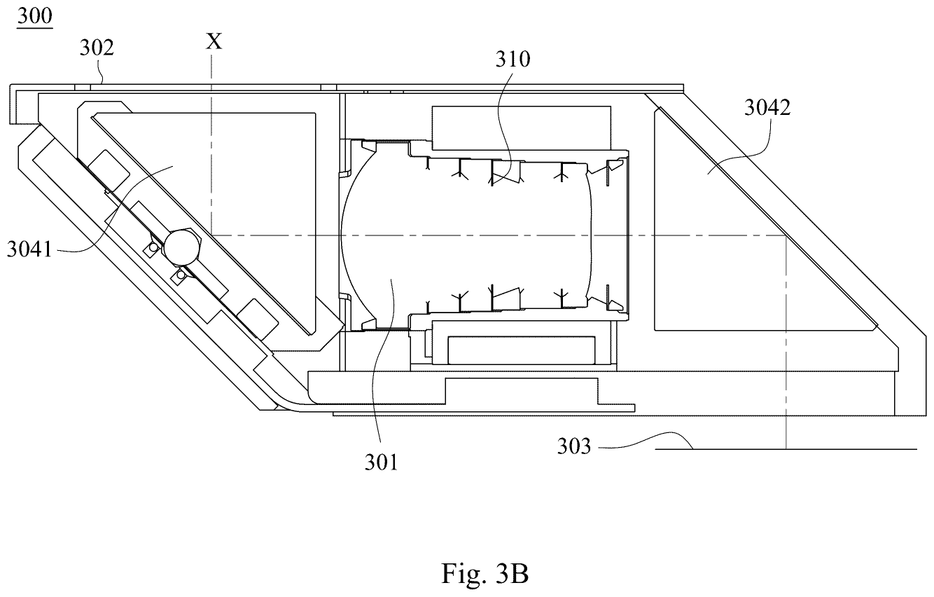

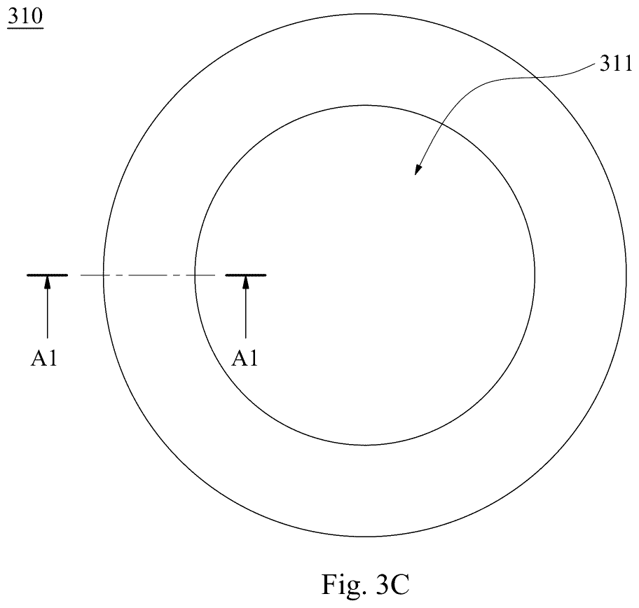

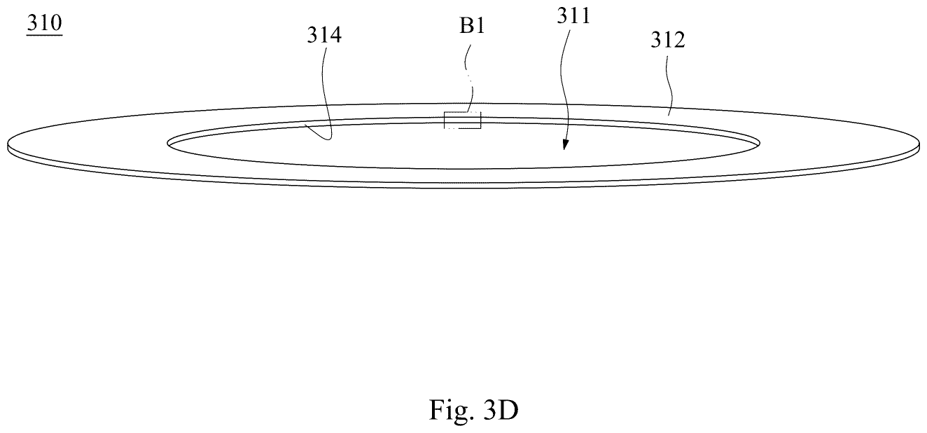

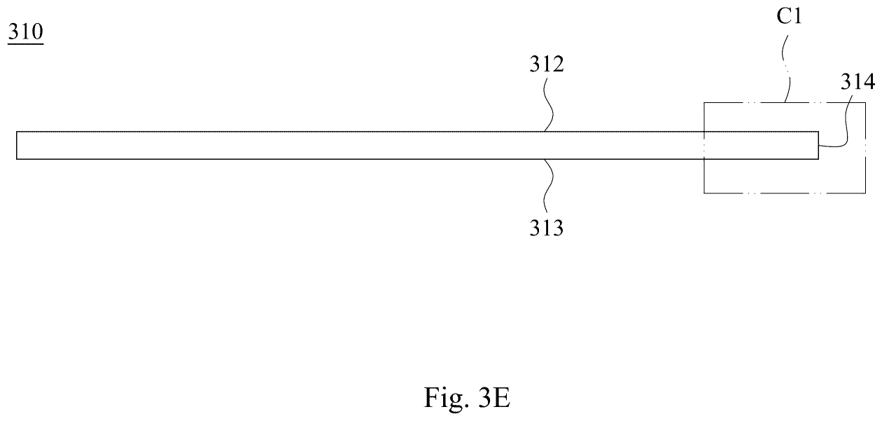

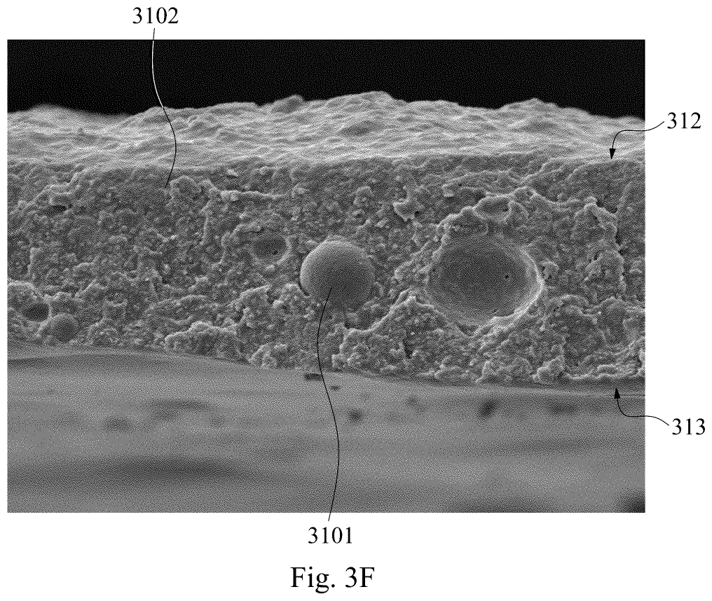

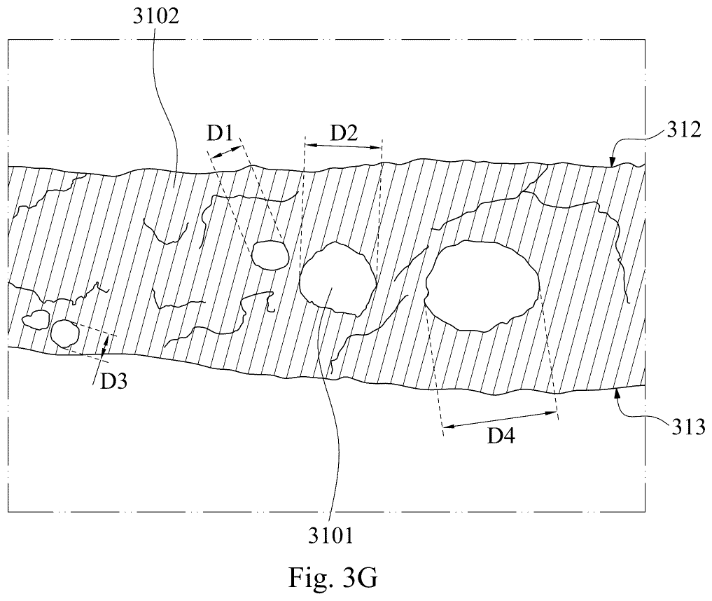

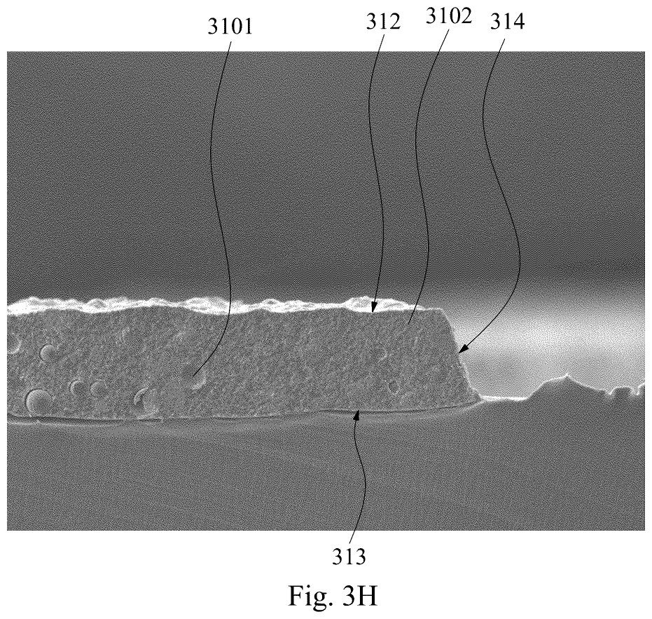

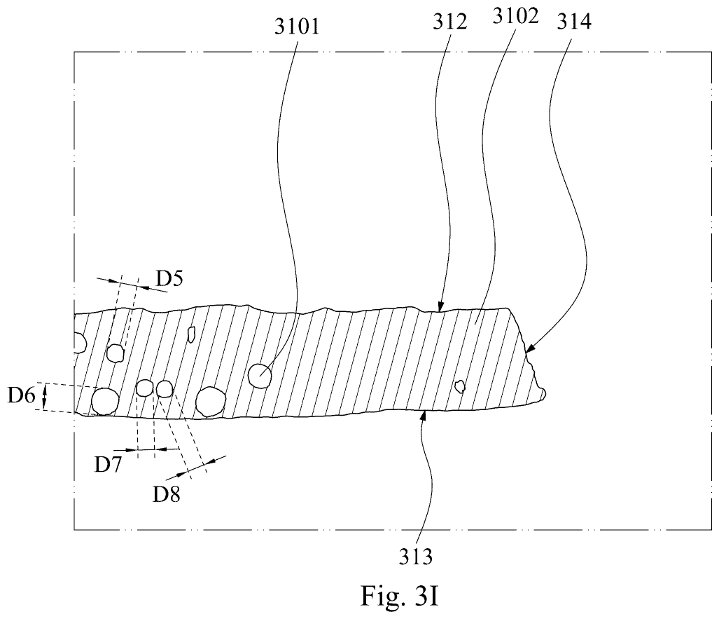

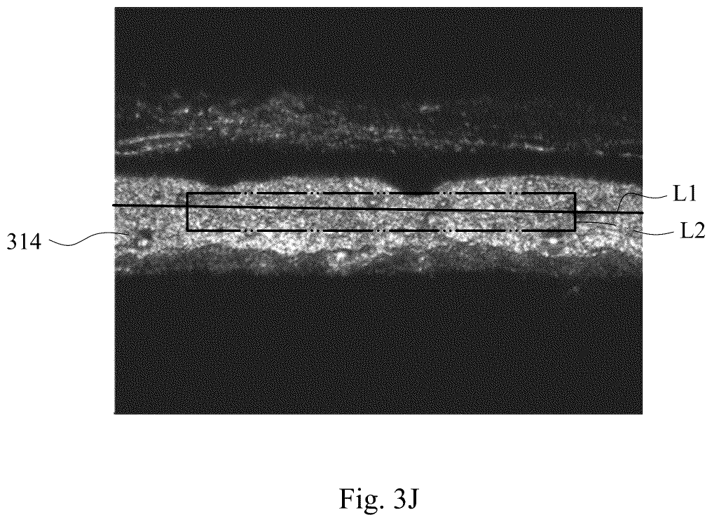

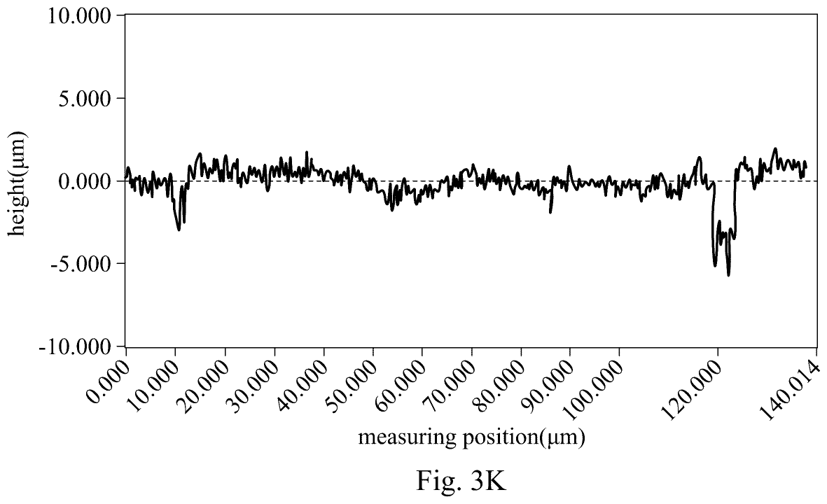

FIG. 3A is a three-dimensional view of an imaging lens assembly module 300 according to the 1st example of the 3rd embodiment of the present disclosure. FIG. 3B is a schematic view of the imaging lens assembly module 300 in FIG. 3A. In FIGS. 3A and 3B, the imaging lens assembly module 300 includes an optical lens assembly 301, two light-folding elements 3041, 3042 and a single layer light blocking sheet 310. The optical lens assembly 301 defines an optical axis X, and can include a plurality of optical lens elements (their reference numerals are omitted) disposed along the optical axis X. The light-folding elements 3041, 3042 are located on an object side and an image side of the optical lens assembly 301, respectively, the light-folding elements 3041, 3042 are located on the optical axis X, and the light-folding elements 3041, 3042 are configured to fold the optical axis X at least once, respectively. The single layer light blocking sheet 310 is disposed between any two of the optical lens elements. Further, the imaging lens assembly module 300 can further include other optical elements according to the requirements, such as a light blocking element, a retainer, but the present disclosure is not limited thereto. Moreover, the imaging lens assembly module 300 can further include a cover 302, wherein the optical lens assembly 301, the single layer light blocking sheet 310 and the light-folding elements 3041, 3042 can be disposed in the cover 302. Therefore, the imaging light enters from the light-folding element 3041 and folded to the optical lens assembly 301, and the imaging light is folded again via the light-folding element 3042 and then imaged on the image surface 303.

FIG. 3C is a schematic view of a single layer light blocking sheet 310 according to the 1st example of the 3rd embodiment in FIG. 3B. FIG. 3D is a three-dimensional view of the single layer light blocking sheet 310 in FIG. 3C. FIG. 3E is a cross-sectional view along an A1-A1 line in FIG. 3C. In FIGS. 3C to 3E, the single layer light blocking sheet 310 includes an object-side surface 312, an image-side surface 313 and a light blocking surface 314. The image-side surface 313 is disposed relative to the object-side surface 312, and is adjacent to an image side of the imaging lens assembly module 300. The light blocking surface 314 connects the object-side surface 312 and the image-side surface 313, and the light blocking surface 314 is closer to the optical axis X than each of the object-side surface 312 and the image-side surface 313 to the optical axis X. The light blocking surface 314 continuously extends around the optical axis X to form a light through hole 311 of the single layer light blocking sheet 310.

FIG. 3F is an image of the SEM of an area B1 in FIG. 3D. FIG. 3G is a schematic view in FIG. 3F. FIG. 3H is an image of the SEM of an area C1 in FIG. 3E. FIG. 3I is a schematic view in FIG. 3H. In FIGS. 3F to 31, the single layer light blocking sheet 310 is formed by a uniform medium 3102, and has a plurality of particles 3101 dispersed in the uniform medium 3102. An appearance of the light blocking surface 314 is undulating. A part of the particles 3101 is exposed from the light blocking surface 314. The particles 3101 can include silicon dioxide material or acrylate material.

According to the 1st example of the 3rd embodiment, a diameter of each of the particles 3101 of the single layer light blocking sheet 310 is D. In particular, the diameters of eight of the particles 3101 in FIGS. 3G and 31 are listed and labelled D1 to D8, respectively, and the values thereof is: D1=2.820 μm, D2=6.038 μm, D3=2.437 μm, D4=8.931 μm, D5=3.808 μm, D6=5.413 μm, D7=3.359 μm, and D8=3.363 μm. It should be mentioned that the above only lists the diameters of a portion of the particles 3101, but the present disclosure is not limited thereto.

FIG. 3J is an image of the SEM of the light blocking surface 314 of the single layer light blocking sheet 310 according to the 1st example of the 3rd embodiment, wherein the measuring range of the related data of the roughness of the light blocking surface 314 of the single layer light blocking sheet 310 of the present disclosure is the area L2 in FIG. 3J. FIG. 3K is a surface roughness profile diagram measuring along a measuring line L1 in FIG. 3J, wherein the horizontal axis is the measuring position on the measuring path, and the unit is μm; the vertical axis is the undulation height of the light blocking surface 314, and the unit is μm. The undulating appearance of the light blocking surface 314 can be quantified via FIGS. 3J and 3K.

According to the 1st example of the 3rd embodiment, a developed interfacial area ratio of the light blocking surface 314 of the single layer light blocking sheet 310 is Sdr; an arithmetic mean peak curvature of the light blocking surface 314 is Spc; an arithmetical mean height of a surface of the light blocking surface 314 is Sa; a gloss difference between the object-side surface 312 and the image-side surface 313 is GL; a surface resistivity of the single layer light blocking sheet 310 is R; a thickness of the single layer light blocking sheet 310 is TH; a maximum height of the light blocking surface 314 is Sz, and the following conditions of Table 3A are satisfied.

TABLE 3A
the 1st example of the 3rd embodiment

| | | | |
|---|---|---|---|
| Sdr | 5.104 | R (Ω/sq) | 1.8 × 10⁶ |
| Spc (mm⁻¹) | 28314.597 | TH (μm) | 21.8 |
| Sa (μm) | 0.636 | Sz (μm) | 12.234 |
| GL | 15.7GU | | |

### 4th Embodiment

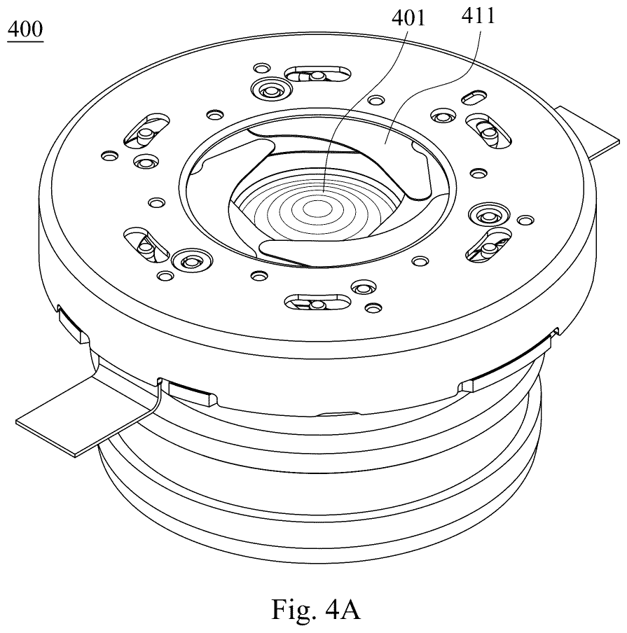

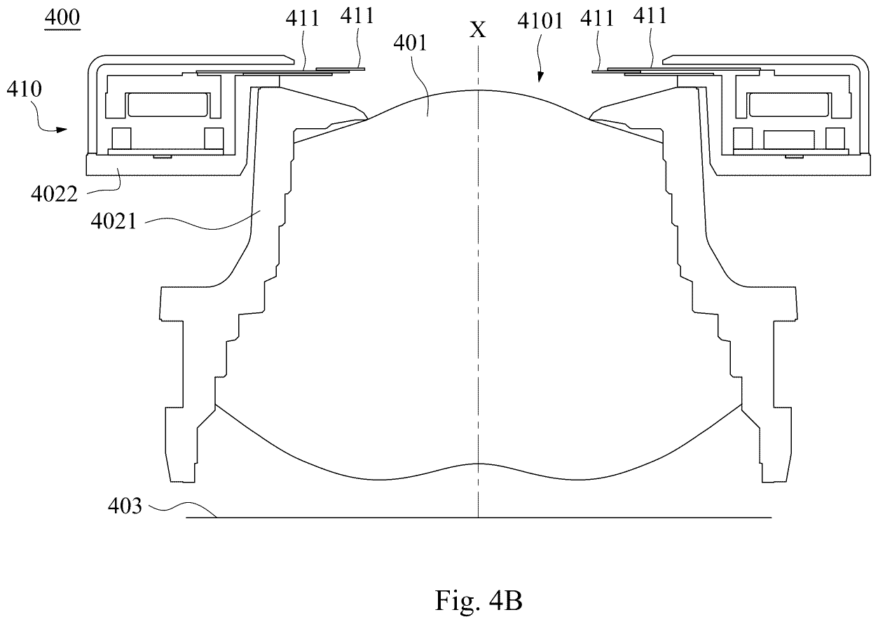

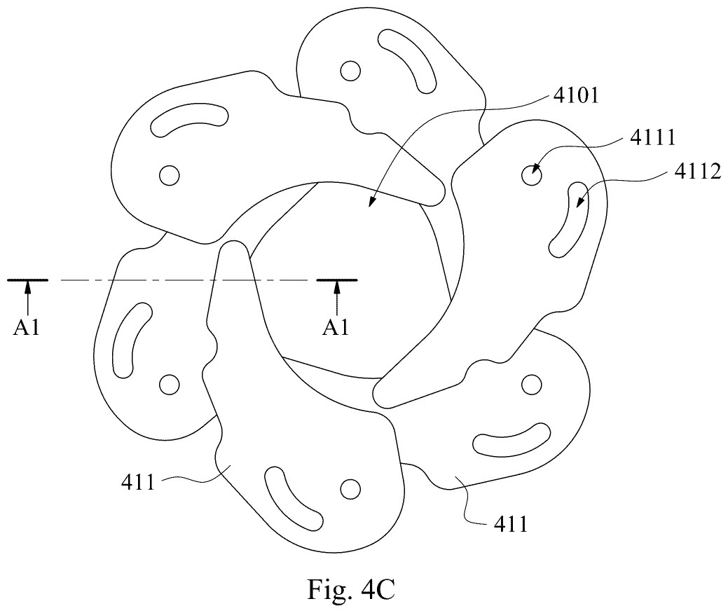

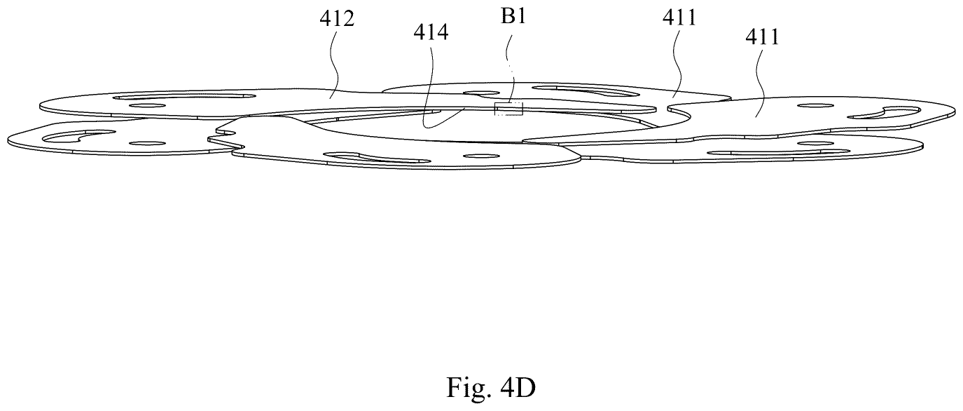

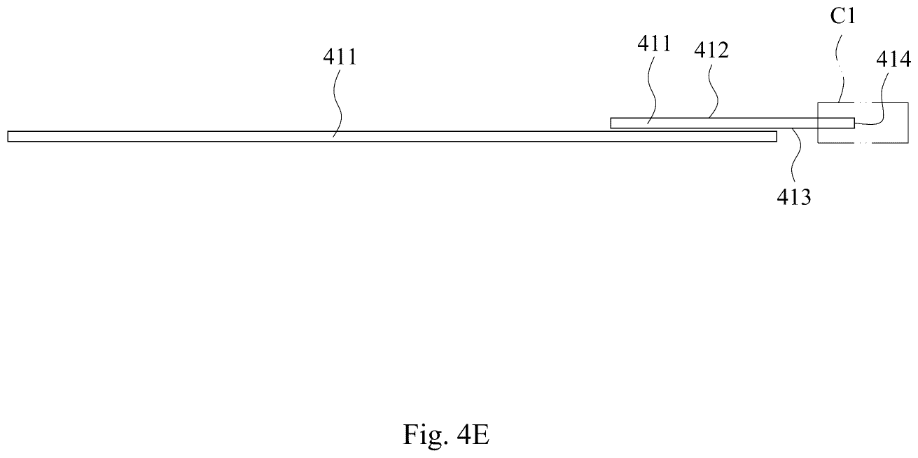

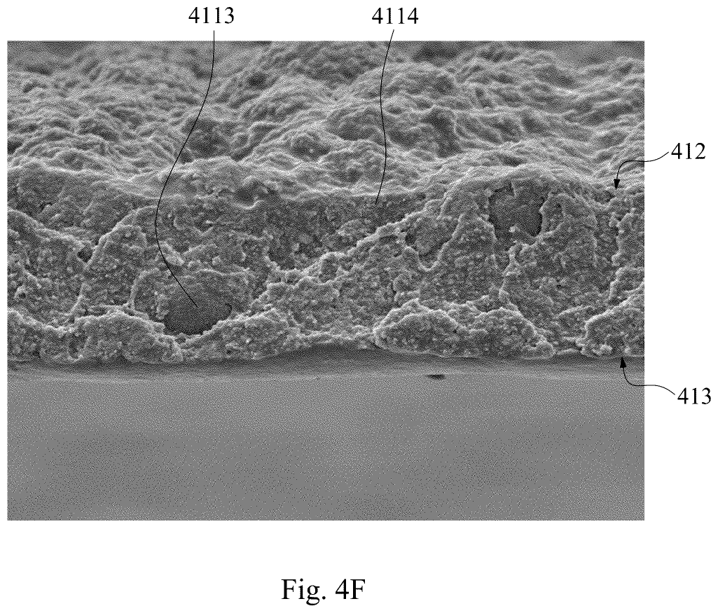

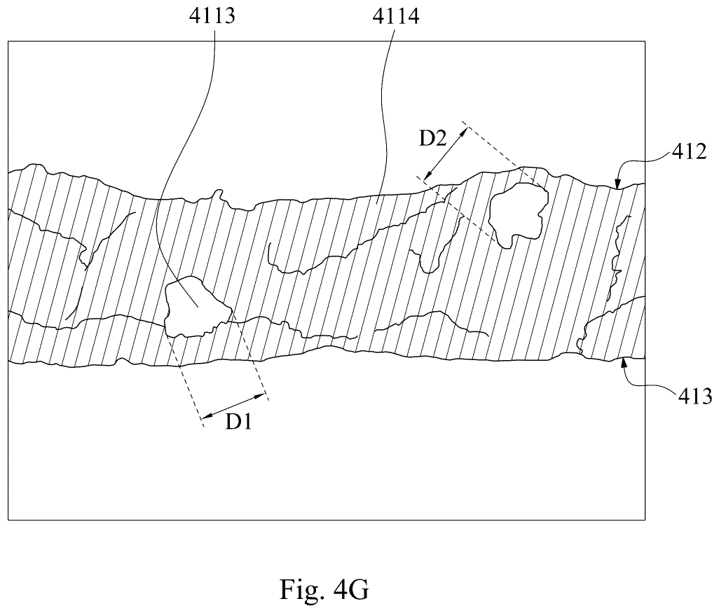

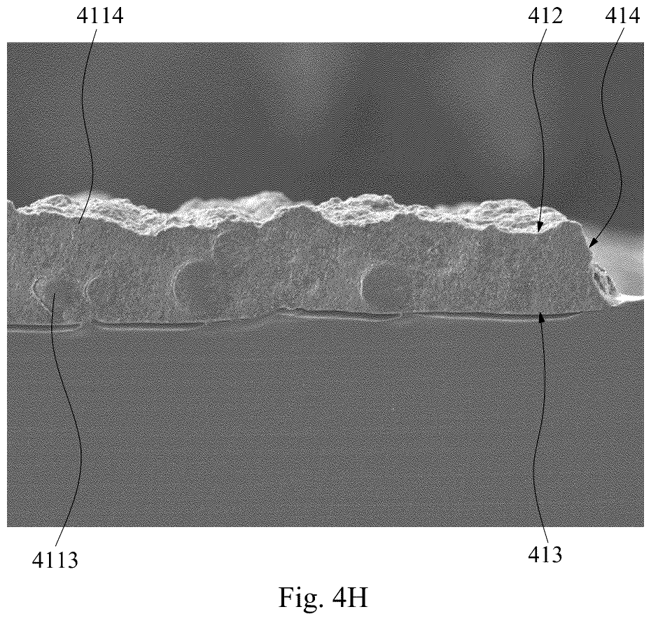

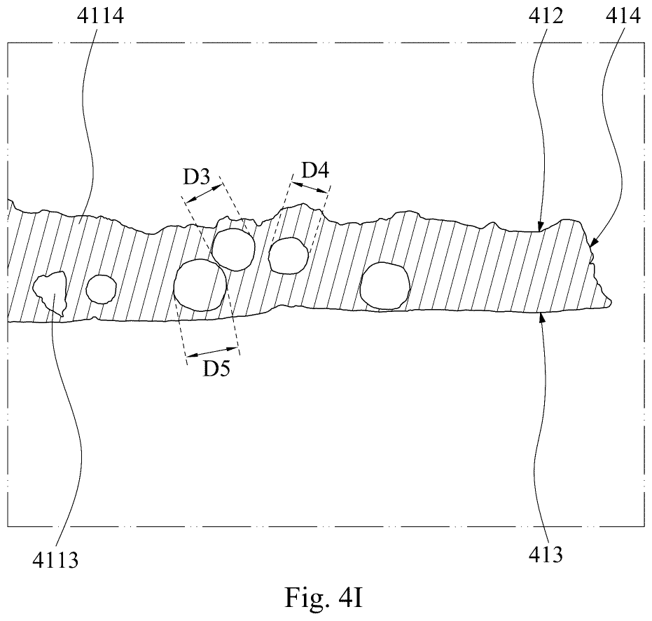

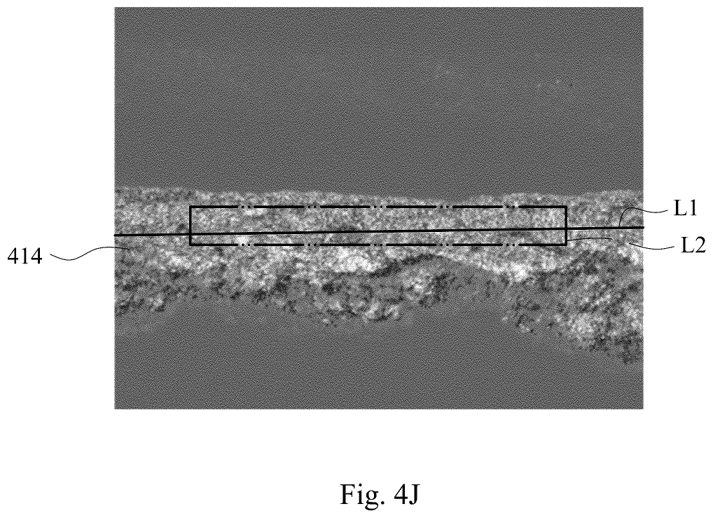

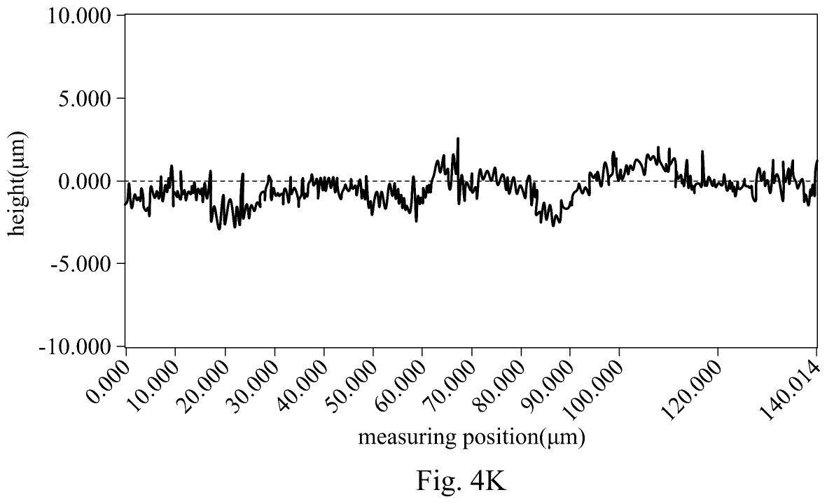

FIG. 4A is a three-dimensional view of an imaging lens assembly module 400 according to the 1st example of the 4th embodiment of the present disclosure. FIG. 4B is a schematic view of the imaging lens assembly module 400 in FIG. 4A. In FIGS. 4A and 4B, the imaging lens assembly module 400 includes an optical lens assembly 401 and a variable aperture module 410. The optical lens assembly 401 defines an optical axis X, and can include a plurality of optical lens elements (their reference numerals are omitted) disposed along the optical axis X. The variable aperture module 410 includes a plurality of single layer light blocking sheets 411 disposed around a circumferential direction of the optical axis X to form a light through hole 4101, and a dimension of the light through hole 4101 is changeable. In particular, the imaging lens assembly module 400 can further include a lens barrel element 4021 and a variable aperture base 4022. The optical lens assembly 401 can be disposed in the lens barrel element 4021, and an image is imaged on an image surface 403. The variable aperture module 410 is connected to the lens barrel element 4021 and positioned on the object side of the optical lens assembly 401 via the variable aperture base 4022. Moreover, the variable aperture module 410 can further include a controlling assembly (its reference numeral is omitted) disposed on the variable aperture base 4022 so as to control the dimension of the light through hole 4101. Further, the imaging lens assembly module 400 can further include other optical elements according to the requirements, such as a light blocking element, a retainer, but the present disclosure is not limited thereto.

FIG. 4C is a schematic view of the plurality of single layer light blocking sheets 411 according to the 1st example of the 4th embodiment in FIG. 4B. FIG. 4D is a three-dimensional view of the plurality of single layer light blocking sheets 411 in FIG. 4C. FIG. 4E is a cross-sectional view along an A1-A1 line in FIG. 4C. In FIGS. 4C to 4E, each of the single layer light blocking sheets 411 includes an object-side surface 412, an image-side surface 413 and a light blocking surface 414. The image-side surface 413 is disposed relative to the object-side surface 412, and is adjacent to an image side of the imaging lens assembly module 400. The light blocking surface 414 connects the object-side surface 412 and the image-side surface 413, the light blocking surface 414 extends around the circumferential direction of the optical axis X, and the light blocking surface 414 is connected to another one of the light blocking surface 414 by observing along a direction of the optical axis X. Each of the single layer light blocking sheets 411 can further include a positioning hole 4111 and a rotating hole 4112. A shape of the positioning hole 4111 is different from a shape of the rotating hole 4112, the positioning hole 4111 can be a circular hole, and the rotating hole 4112 can be a strip-shaped hole extending towards a direction of the light through hole 4101. The positioning hole 4111 is configured to position the single layer light blocking sheets 411 on the variable aperture module 410, and the rotating hole 4112 is configured to provide a moving path so as to make the single layer light blocking sheets 411 to be movable, so that the light through hole 4101 can be changeable.

FIG. 4F is an image of the SEM of an area B1 in FIG. 4D. FIG. 4G is a schematic view in FIG. 4F. FIG. 4H is an image of the SEM of an area C1 in FIG. 4E. FIG. 4I is a schematic view in FIG. 4H. In FIGS. 4F to 41, each of the single layer light blocking sheets 411 of the variable aperture module 410 is formed by a uniform medium 4114, and has a plurality of particles 4113 is dispersed in the uniform medium 4114. An appearance of the light blocking surface 414 is undulating. A part of the particles 4113 is exposed from the light blocking surface 414. The particles 4113 can include silicon dioxide material or acrylate material.

According to the 1st example of the 4th embodiment, a diameter of each of the particles 4113 of each of the single layer light blocking sheets 411 is D. In particular, the diameters of five of the particles 4113 in FIGS. 4G and 41 are listed and labelled D1 to D5, respectively, and the values thereof is: D1=4.918 μm, D2=4.091 μm, D3=8.683 μm, D4=7.817 μm, and D5=11.110 μm. It should be mentioned that the above only lists the diameters of a portion of the particles 4113, but the present disclosure is not limited thereto.

FIG. 4J is an image of the SEM of the light blocking surface 414 of one of the single layer light blocking sheets 411 according to the 1st example of the 4th embodiment, wherein the measuring range of the related data of the roughness of the light blocking surface 414 of one of the single layer light blocking sheets 411 of the present disclosure is the area L2 in FIG. 4J. FIG. 4K is a surface roughness profile diagram measuring along a measuring line L1 in FIG. 4J, wherein the horizontal axis is the measuring position on the measuring path, and the unit is μm; the vertical axis is the undulation height of the light blocking surface 414, and the unit is μm. The undulating appearance of the light blocking surface 414 can be quantified via FIGS. 4J and 4K.

According to the 1st example of the 4th embodiment, a developed interfacial area ratio of the light blocking surface 414 of each of the single layer light blocking sheets 411 is Sdr; an arithmetic mean peak curvature of the light blocking surface 414 is Spc; an arithmetical mean height of a surface of the light blocking surface 414 is Sa; a gloss difference between the object-side surface 412 and the image-side surface 413 is GL; a surface resistivity of each of the single layer light blocking sheets 411 is R; a thickness of each of the single layer light blocking sheets 411 is TH; a maximum height of the light blocking surface 414 is Sz, and the following conditions of Table 4A are satisfied.

TABLE 4A
the 1st example of the 4th embodiment

| | | | |
|---|---|---|---|
| Sdr | 9.764 | R (Ω/sq) | 1.8 × 10⁶ |
| Spc (mm⁻¹) | 72862.323 | TH (μm) | 23.5 |
| Sa (μm) | 0.795 | Sz (μm) | 7.845 |
| GL | 18.7GU | | |

### 5th Embodiment

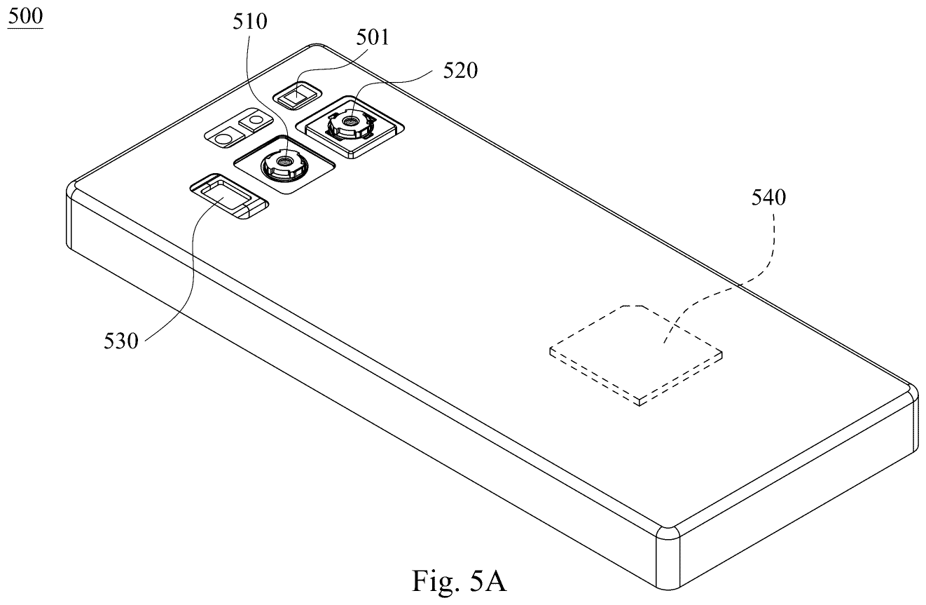

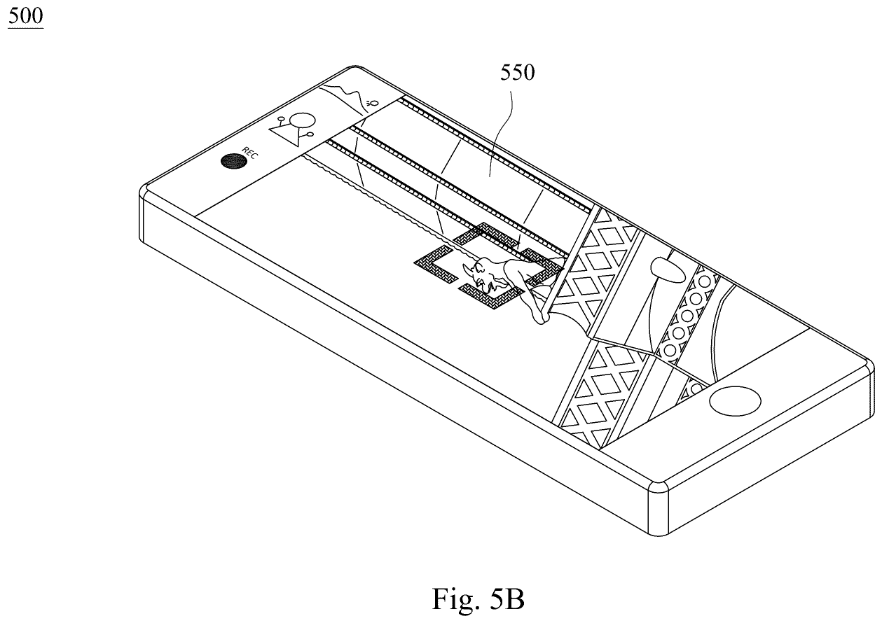

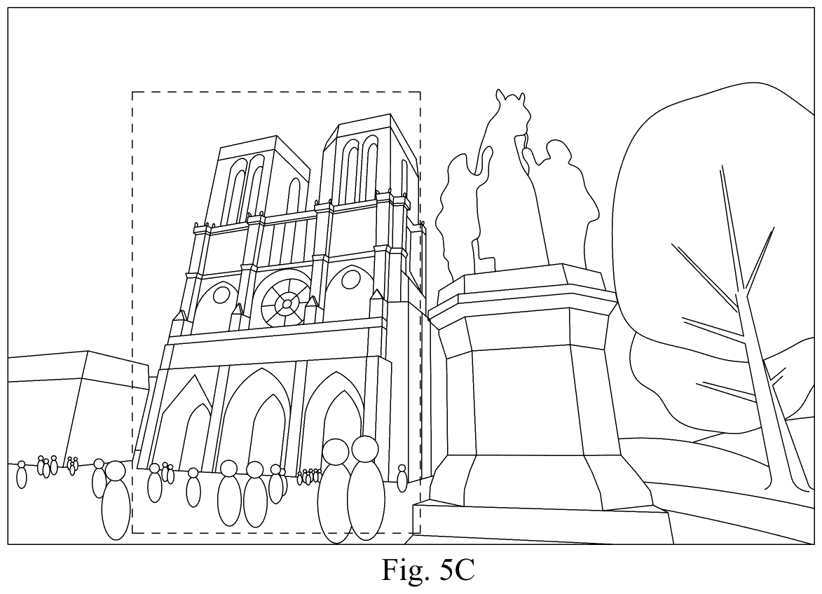

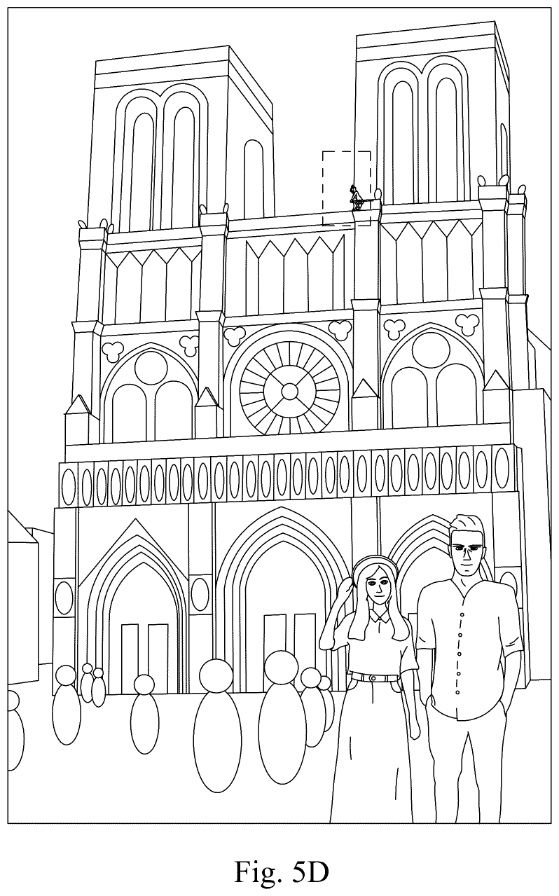

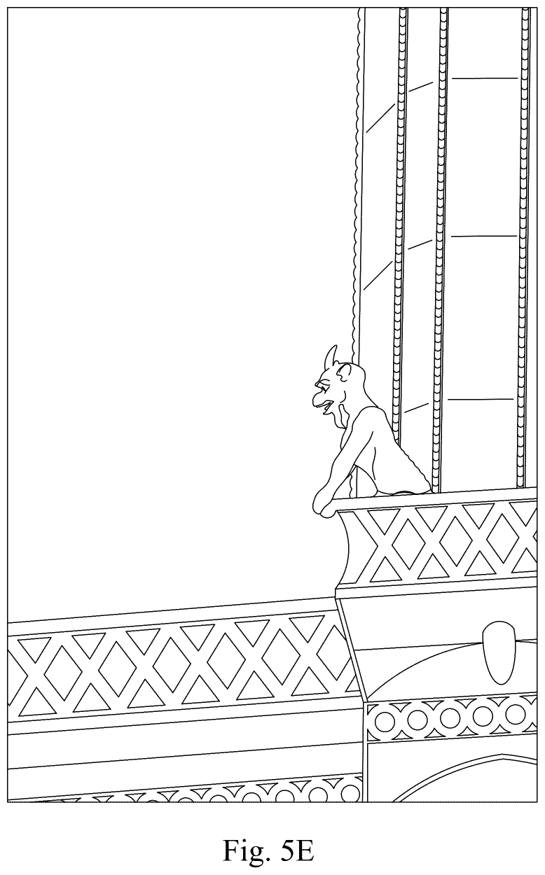

FIG. 5A is a schematic view of an electronic device 500 according to the 5th embodiment of the present disclosure. FIG. 5B is another schematic view of the electronic device 500 according to the 5th embodiment in FIG. 5A. In FIGS. 5A and 5B, the electronic device 500 is a smart phone, and includes a plurality of camera modules, a plurality of image sensors and a user interface 550, wherein each of the image sensors is disposed on an image surface of each of the camera modules. Moreover, the camera modules are a high resolution camera module 510, an ultra-wide angle camera module 520 and a telephoto camera module 530, and the user interface 550 is a touch screen, but the present disclosure is not limited thereto. In particular, the camera modules can include one of the imaging lens assembly modules according to the aforementioned 1st embodiment to the 4th embodiment, but the present disclosure is not limited thereto.

Users enter a shooting mode via the user interface 550, wherein the user interface 550 is configured to display the scene, and the shooting angle can be manually adjusted to switch the high resolution camera module 510, the ultra-wide angle camera module 520 and the telephoto camera module 530. At this moment, the imaging light is gathered on each of the image sensors via each of the camera modules, and an electronic signal about an image is output to an image signal processor (ISP) 540.

In FIG. 5A, to meet a specification of the electronic device 500, the electronic device 500 can further include an optical anti-shake mechanism (not shown). Furthermore, the electronic device 500 can further include at least one focusing assisting module (its reference numeral is omitted) and at least one sensing element (not shown). The focusing assisting module can be a flash module 501 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera modules of the electronic device 500 equipped with an auto-focusing mechanism and the optical anti-shake mechanism can be enhanced to achieve the superior image quality. Furthermore, the electronic device 500 according to the present disclosure can have a capturing function with multiple modes, such as taking optimized selfies, high dynamic range (HDR) under a low light condition, 4K resolution recording and so on. Furthermore, the users can visually see a captured image of the camera through the user interface 550 and manually operate the view finding range on the user interface 550 to achieve the autofocus function of what you see is what you get.

Moreover, the camera modules, the image sensor, the optical anti-shake mechanism, the sensing element and the focusing assisting module can be disposed on a flexible printed circuit board (FPC) (not shown) and electrically connected to the associated components, such as the image signal processor 540, via a connector (not shown) to perform a capturing process. Since the current electronic devices, such as smart phones, have a tendency of being compact, the way of firstly disposing the camera modules and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the camera modules can also be controlled more flexibly via the touch screen of the electronic device. According to the 5th embodiment, the electronic device 500 can include a plurality of sensing elements and a plurality of focusing assisting modules. The sensing elements and the focusing assisting modules are disposed on the flexible printed circuit board and at least one other flexible printed circuit board (not shown) and electrically connected to the associated components, such as the image signal processor 540, via corresponding connectors to perform the capturing process. In other examples (not shown herein), the sensing elements and the focusing assisting modules can also be disposed on the main board of the electronic device or carrier boards of other types according to requirements of the mechanical design and the circuit layout.

Furthermore, the electronic device 500 can further include, but not be limited to, a display, a control unit, a storage unit, a random access memory (RAM), a read-only memory (ROM), or the combination thereof.

FIG. 5C is a schematic view of an image captured via the electronic device 500 according to the 5th embodiment in FIG. 5A. In FIG. 5C, the larger range of the image can be captured via the ultra-wide angle camera module 520, and the ultra-wide angle camera module 520 has the function of accommodating wider range of the scene.

FIG. 5D is another schematic view of an image captured via the electronic device 500 according to the 5th embodiment in FIG. 5A. In FIG. 5D, the image of the certain range with the high resolution can be captured via the high resolution camera module 510, and the high resolution camera module 510 has the function of the high resolution and the low deformation.

FIG. 5E is another schematic view of an image captured via the electronic device 500 according to the 5th embodiment in FIG. 5A. In FIG. 5E, the telephoto camera module 530 has the enlarging function of the high magnification, and the distant image can be captured and enlarged with high magnification via the telephoto camera module 530.

In FIGS. 5C to 5E, the zooming function can be obtained via the electronic device 500, when the scene is captured via the camera modules with different focal lengths cooperated with the function of image processing.

### 6th Embodiment

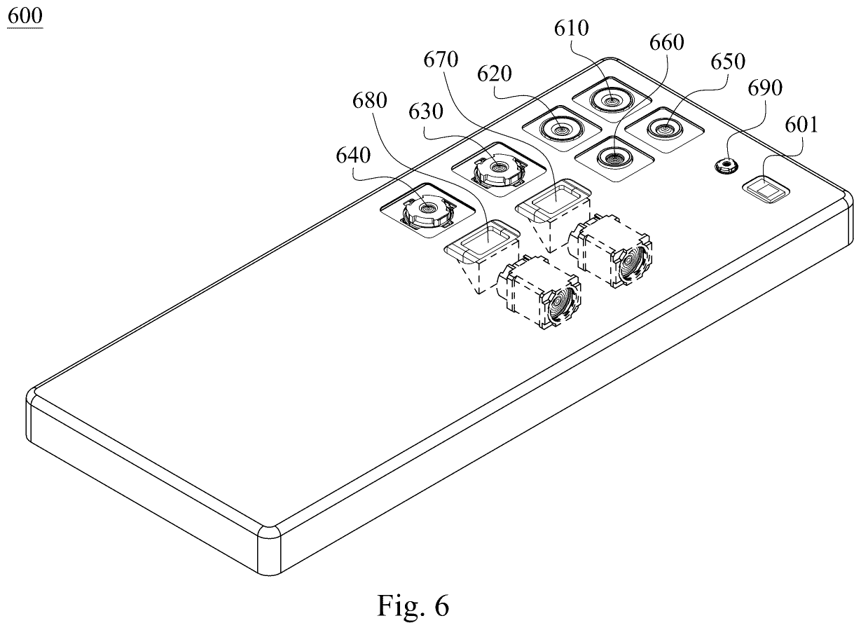

FIG. 6 is a schematic view of an electronic device 600 according to the 6th embodiment of the present disclosure. In FIG. 6, the electronic device 600 is a smart phone, and includes a plurality of camera modules and a plurality of image sensors, wherein each of the image sensors is disposed on an image surface of each of the camera modules. Moreover, the camera modules are ultra-wide angle camera modules 610, 620, wide angle camera modules 630, 640, telephoto camera modules 650, 660, 670, 680 and a Time-Of-Flight (TOF) module 690. The TOF module 690 can be another type of the camera module, and the disposition is not limited thereto. In particular, the camera modules can include one of the imaging lens assembly modules according to the aforementioned 1st embodiment to the 4th embodiment, but the present disclosure is not limited thereto.

Further, the telephoto camera modules 670, 680 are configured to fold the light, but the present disclosure is not limited thereto.

To meet a specification of the electronic device 600, the electronic device 600 can further include an optical anti-shake mechanism (not shown). Furthermore, the electronic device 600 can further include at least one focusing assisting module (not shown) and at least one sensing element (not shown). The focusing assisting module can be a flash module 601 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera modules of the electronic device 600 equipped with an auto-focusing mechanism and the optical anti-shake mechanism can be enhanced to achieve the superior image quality. Furthermore, the electronic device 600 according to the present disclosure can have a capturing function with multiple modes, such as taking optimized selfies, High Dynamic Range (HDR) under a low light condition, 4K Resolution recording and so on.

Further, all of other structures and dispositions according to the 6th embodiment are the same as the structures and the dispositions according to the 5th embodiment, and will not be described again herein.

### 7th Embodiment

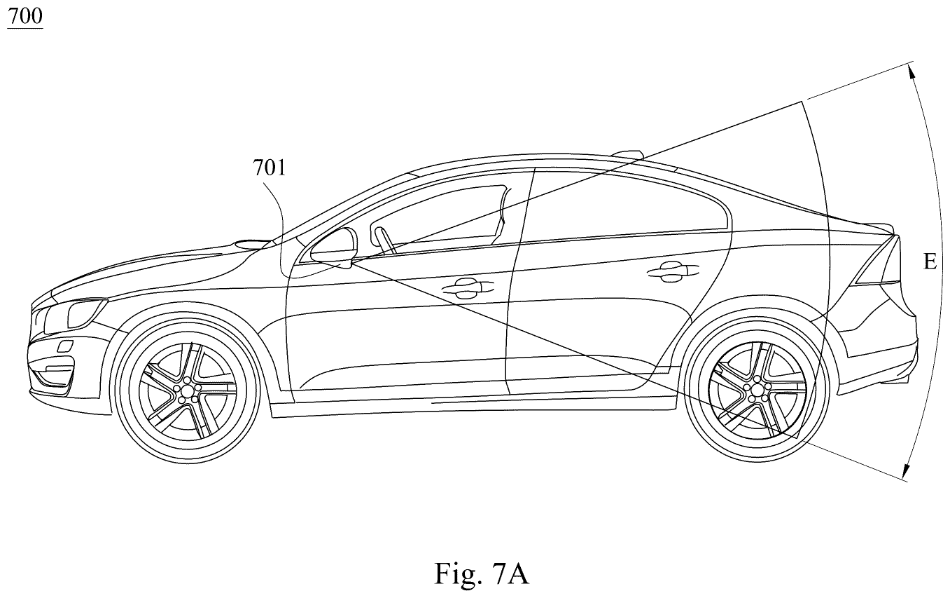

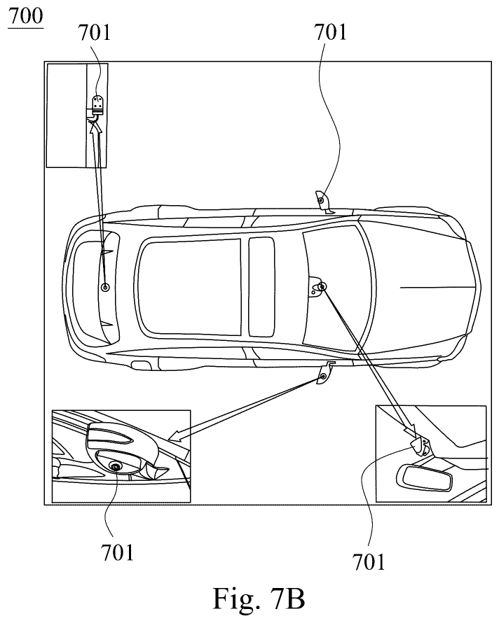

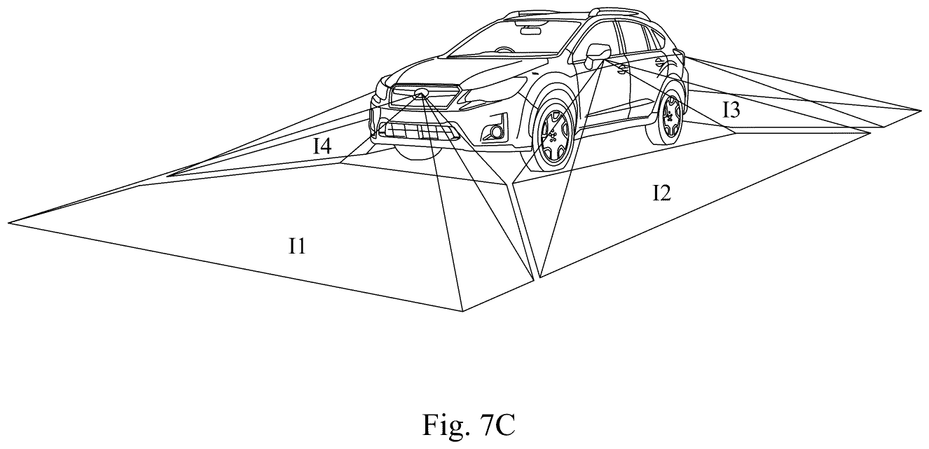

FIG. 7A is a schematic view of a vehicle instrument 700 according to the 7th embodiment of the present disclosure. FIG. 7B is another schematic view of the vehicle instrument 700 according to the 7th embodiment in FIG. 7A. FIG. 7C is another schematic view of the vehicle instrument 700 according to the 7th embodiment in FIG. 7A. In FIGS. 7A to 7C, the vehicle instrument 700 includes a plurality of camera modules 701 and a plurality of image sensors, wherein each of the image sensors is disposed on an image surface of each of the camera modules 701. According to the 7th embodiment, a number of the camera modules 701 is six, and the camera modules 701 can include one of the imaging lens assembly modules according to the aforementioned 1st embodiment to the 4th embodiment, but the present disclosure is not limited thereto.

In FIGS. 7A and 7B, the camera modules 701 are automotive camera modules, two of the camera modules 701 are located under rearview mirrors on a left side and a right side, respectively, and the aforementioned camera modules 701 are configured to capture the image information of a visual angle E. In particular, the visual angle E can satisfy the following condition: 40 degrees<E<90 degrees. Therefore, the image information in the regions of two lanes on the left side and the right side can be captured.

In FIG. 7B, another two of the camera modules 701 can be disposed in the inner space of the vehicle instrument 700. In particular, the aforementioned two camera modules 701 are disposed on a location close to the rearview mirror inside the vehicle instrument 700 and a location close to the rear car window, respectively. Moreover, the camera modules 701 can be further disposed on the rearview mirrors on the left side and the right side except the mirror surface, respectively, but the present disclosure is not limited thereto.

In FIG. 7C, another two of the camera modules 701 can be disposed on a front end of the vehicle instrument 700 and a rear end of the vehicle instrument 700, respectively. By disposing the camera modules 701 on the front end and the rear end of the vehicle instrument 700 and under the rearview mirror on the left side of the vehicle instrument 700 and the right side of the vehicle instrument 700, it is favorable for the drivers obtaining the external space information in addition to the driving seat, such as the external space informations I1, I2, I3, I4, but the present disclosure is not limited thereto. Therefore, more visual angles can be provided to reduce the blind spot, so that the driving safety can be improved. Further, the traffic information outside of the vehicle instrument 700 can be recognized by disposing the camera modules 701 on the periphery of the vehicle instrument 700, so that the function of the automatic driving assistance can be achieved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An imaging lens assembly module, comprising:
an optical lens assembly defining an optical axis; and
a single layer light blocking sheet formed by a uniform medium, having a plurality of particles dispersed in the uniform medium, and the single layer light blocking sheet comprising:
an object-side surface;
an image-side surface disposed relative to the object-side surface, and being adjacent to an image side of the imaging lens assembly module; and
a light blocking surface connecting the object-side surface and the image-side surface, and the light blocking surface closer to the optical axis than each of the object-side surface and the image-side surface to the optical axis;
wherein, an appearance of the light blocking surface is undulating, a developed interfacial area ratio of the light blocking surface is Sdr, an arithmetic mean peak curvature of the light blocking surface is Spc, and the following conditions are satisfied:
$$1.5 < Sdr < 25 ; and$$
$$15000 {mm}^{- 1} < Spc < 150000 {mm}^{- 1} .$$

2. The imaging lens assembly module of claim 1, wherein a part of the particles are exposed from the light blocking surface.

3. The imaging lens assembly module of claim 1, wherein the developed interfacial area ratio of the light blocking surface is Sdr, and the following condition is satisfied:
$$3 < Sdr < 15.$$

4. The imaging lens assembly module of claim 1, wherein the arithmetic mean peak curvature of the light blocking surface is Spc, and the following condition is satisfied:
$$20000 {mm}^{- 1} < Spc < 100000 {mm}^{- 1} .$$

5. The imaging lens assembly module of claim 1, wherein a diameter of each of the particles is D, and the following condition is satisfied:
$$0.5 µm < D < 22 µm .$$

6. The imaging lens assembly module of claim 1, wherein the particles comprise silicon dioxide material or acrylate material.

7. The imaging lens assembly module of claim 1, wherein an arithmetical mean height of a surface of the light blocking surface is Sa, and the following condition is satisfied:
$$0.3 µm < Sa < 2.3 µm .$$

8. The imaging lens assembly module of claim 1, wherein a gloss difference between the object-side surface and the image-side surface is GL, and the following condition is satisfied:
$$1 GU < GL < 30 GU .$$

9. The imaging lens assembly module of claim 1, wherein the light blocking surface continuously extends around the optical axis to form a light through hole of the single layer light blocking sheet, and the light through hole is roughly circular.

10. The imaging lens assembly module of claim 1, further comprising:
a light-folding element located on the optical axis, and the light-folding element configured to fold the optical axis at least once;
wherein the single layer light blocking sheet is disposed on the light-folding element relative to a travelling direction of the optical axis.

11. The imaging lens assembly module of claim 10, wherein the light blocking surface extends towards a direction of the optical axis after folding.

12. The imaging lens assembly module of claim 1, wherein a surface resistivity of the single layer light blocking sheet is R, and the following condition is satisfied:
$$1 {0}^{3} Ω / sq < R < 1 {0}^{8} Ω / sq .$$

13. The imaging lens assembly module of claim 1, wherein a thickness of the single layer light blocking sheet is TH, and the following condition is satisfied:
$$10 µm < TH < 45 µm .$$

14. The imaging lens assembly module of claim 1, wherein the developed interfacial area ratio of the light blocking surface is Sdr, the arithmetic mean peak curvature of the light blocking surface is Spc, a diameter of each of the particles is D, an arithmetical mean height of a surface of the light blocking surface is Sa, and the following conditions are satisfied:
$$5.104 \leq Sdr \leq 11.45 ;$$
$$28314.597 {mm}^{- 1} \leq Spc \leq 72862.323 {mm}^{- 1} ;$$
$$1.807 µm \leq D \leq 11.11 µm ; and$$
$$0.636 µm \leq Sa \leq 1.144 µm .$$

15. An electronic device, comprising:
the imaging lens assembly module of claim 1.

16. An imaging lens assembly module, comprising:
an optical lens assembly defining an optical axis; and
a variable aperture module, comprising:
a plurality of single layer light blocking sheets disposed around a circumferential direction of the optical axis to form a light through hole, a dimension of the light through hole being changeable, each of the single layer light blocking sheets formed by a uniform medium, and having a plurality of particles dispersed in the uniform medium, and each of the single layer light blocking sheets comprising:
an object-side surface;
an image-side surface disposed relative to the object-side surface, and being adjacent to an image side of the imaging lens assembly module; and
a light blocking surface connecting the object-side surface and the image-side surface, the light blocking surface extending around the circumferential direction, and the light blocking surface connected to another one of the light blocking surface by observing along a direction of the optical axis;
wherein, an appearance of the light blocking surface is undulating.

17. The imaging lens assembly module of claim 16, wherein a part of the particles are exposed from the light blocking surface.

18. The imaging lens assembly module of claim 16, wherein each of the single layer light blocking sheets further comprises a positioning hole and a rotating hole.

19. The imaging lens assembly module of claim 18, wherein a shape of the positioning hole is different from a shape of the rotating hole, the positioning hole is a circular hole, and the rotating hole is a strip-shaped hole extending towards a direction of the light through hole.

20. The imaging lens assembly module of claim 16, wherein a developed interfacial area ratio of the light blocking surface is Sdr, and the following condition is satisfied:
$$1 < Sdr < 25.$$

21. The imaging lens assembly module of claim 20, wherein the developed interfacial area ratio of the light blocking surface is Sdr, and the following condition is satisfied:
$$3 < Sdr < 15.$$

22. The imaging lens assembly module of claim 16, wherein an arithmetic mean peak curvature of the light blocking surface is Spc, and the following condition is satisfied:
$$15000 {mm}^{- 1} < Spc < 150000 {mm}^{- 1} .$$

23. The imaging lens assembly module of claim 22, wherein the arithmetic mean peak curvature of the light blocking surface is Spc, and the following condition is satisfied:
$$20000 {mm}^{- 1} < Spc < 100000 {mm}^{- 1} .$$

24. The imaging lens assembly module of claim 16, wherein a diameter of each of the particles is D, and the following condition is satisfied:
$$0.5 µm < D < 22 µm .$$

25. The imaging lens assembly module of claim 16, wherein the particles comprise silicon dioxide material or acrylate material.

26. The imaging lens assembly module of claim 16, wherein an arithmetical mean height of a surface of the light blocking surface is Sa, and the following condition is satisfied:
$$0.3 µm < Sa < 2.3 µm .$$

27. The imaging lens assembly module of claim 16, wherein a surface resistivity of each of the single layer light blocking sheets is R, and the following condition is satisfied:
$$1 {0}^{3} Ω / sq < R < 1 {0}^{8} Ω / sq .$$

28. An electronic device, comprising:
the imaging lens assembly module of claim 16.
